(19) United States
(12) Patent Application Publication
(10) Pub. No.: US 2010/0001822 A1
(43) Pub. Date: Jan. 7, 2010

(54) METHODS AND CONFIGURATIONS OF LC COMBINED TRANSFORMERS AND EFFECTIVE UTILIZATIONS OF CORES THEREIN

(76) Inventors: Chun Li, Toronto (CA); Jason (Jian Hao) Li, Toronto (CA); Ran Ran Li, Toronto (CA)

Correspondence Address: Chun Li, 163-70 Driftwood Ave., Toronto, ON, M3N 2M5, CA

(21) Appl. No.: 12/166,322

(22) Filed: Jul. 2, 2008

(51) Int. Cl. H01F 17/00

(52) U.S. Cl. 336/105

(57) ABSTRACT

This invention presents the LC combined transformer, a combination of capacitances, inductances and an electrically-isolated mutual inductor, i.e. conventional transformer. To improve the imperfections of the widely-used transformers, by means of the simplest passive-circuit design of perfectly-functionally mating mutual capacitors with the mutual inductor, the invention achieves optimal characteristics of current or/and voltage conversions, with a new property of waveform conversion from square-wave to quasi-sinusoid. The ideal current transformers herein are suited to sinusoidal current measurements, the ideal voltage transformers suited to sinusoidal voltage measurements, and they all could be upgraded to ideal transformers, capable of current and voltage conversions. They can also be designed as both power transferable and waveform convertible, applicable in power electronics. Herein also states the design approach of integrated inductor and mutual inductor and the usage of push-pull inductor, materials being fully utilized and sizes greatly decreased.

### FIELD OF THE INVENTION

This invention relates to a transformer which is a combination of capacitances, inductances and also an electrically-isolated mutual inductor (namely, conventional transformer), and called LC combined transformer.

### BACKGROUND OF THE INVENTION

It is well known that the electric transformer, i.e. the conventional voltage/current transformer, widely-used in electrical engineering is actually a mutual inductor with its coupling coefficient k less than but close to 1. In order to address this issue more clearly, for the time being, let's review its electric characteristic equations when neglecting power loss. As the port variables of a mutual inductor supposed as corresponding to those illustrated in FIG. 1(a), in electrical theory, its electrical characteristic equations in a sinusoidal steady-state circuit are presented as

$$\{ \begin{matrix}{V}_{1} = jω {L}_{1} {I}_{1} - jω M {I}_{2} \\ {V}_{2} = jω M {I}_{1} - jω {L}_{2} {I}_{2}\end{matrix} \qquad \begin{matrix}( 1 ) \\ ( 2 )\end{matrix}$$

where L₁ and L₂ respectively represent self-inductances of the primary winding and the secondary winding of the mutual inductor, M the mutual inductance between them both; ω=2πf. And attention must be paid to its coupling coefficient k and turns ratio n, defined as

$$\begin{matrix}k = \frac{M}{\sqrt{{L}_{1} {L}_{2}}} & ( 3 ) \\ n = \frac{{N}_{1}}{{N}_{2}} = \sqrt{\frac{{L}_{1}}{{L}_{2}}} & ( 4 )\end{matrix}$$

Obviously, the mutual inductor in FIG. 1(a) can be electrically equalized as in FIG. 1(b), with its equations accordingly equivalently transformed as follows.

$$\begin{matrix}\{ \begin{matrix}\begin{matrix}{V}_{a} = {V}_{1} - jω ( 1 - k ) {L}_{1} {I}_{1} = jω {kL}_{1} {I}_{1} - \\ jω k \sqrt{{L}_{1} {L}_{2}} {I}_{2} = \sqrt{{L}_{1}} ( jω k \sqrt{{L}_{1}} {I}_{1} - jω k \sqrt{{L}_{2}} {I}_{2} )\end{matrix} \\ {V}_{b} = {V}_{2} + jω ( 1 - k ) {L}_{2} {I}_{2} = jω k \sqrt{{L}_{1} {L}_{2}} {I}_{1} - \\ jω {kL}_{2} {I}_{2} = \sqrt{{L}_{2}} ( jω k \sqrt{{L}_{1}} {I}_{1} - jω k \sqrt{{L}_{2}} {I}_{2} )\end{matrix} & \begin{matrix}( 5 ) \\ \\ \begin{matrix} \\ ( 6 )\end{matrix}\end{matrix} \\ {I}_{1} = \frac{{V}_{a}}{jω {kL}_{1}} + \sqrt{\frac{{L}_{2}}{{L}_{1}}} {I}_{2} = \frac{{V}_{a}}{jω {kL}_{1}} + \frac{1}{n} {I}_{2} = {I}_{0} + \frac{1}{n} {I}_{2} & ( 7 )\end{matrix}$$

In FIG. 1(b), enclosed in the broken-line box is an ideal transformer that has the simplest voltage and current relations between ports as Vₐ/V_{b}=n, I₁′/I₂=1/n . From Eqs. (5), (6) and (7), for a practical voltage/current transformer or mutual inductor, its voltage ratio is

$$n = \frac{{N}_{1}}{{N}_{2}} = \frac{{V}_{a}}{{V}_{b}} \neq \frac{{V}_{1}}{{V}_{2}} ,$$

and its current ratio is

$${I}_{1} = {I}_{0} + \frac{1}{n} {I}_{2} \neq \frac{1}{n} {I}_{2} , ( {I}_{0} \neq 0 ) ;$$

which means that it is actually not precise either being used as a voltage transformer for voltage measurement or as a current transformer for current measurement, and that errors exist in it substantially, being determined by the deficiency in its structural principle. The error caused from its leakage inductances (1−k)L₁ and (1−k )L₂ and magnetization inductance kL₁ is called reactive error [Note: Reactive error not only worsens the transforming precision but also increases reactive current of the supply so as to cause more power loss and wastes for transmission line materials]. In addition, there exist the power-dissipation error, or resistive error, from its copper loss and iron loss as well as its non-linearity error from its non-linear cores. Therefore, to meet its required precision, the conventional transformer had to resort to lots of methods for improvements while designed.

Furthermore, due to complexity of the network loads, there disperse great numbers of higher harmonic waves in the supply network. The higher harmonics not only contribute to energy wastes but also endanger the safety of facilities and loads, causing misoperations and mishaps, seriously interfering with signal transmissions. The conventional transformer is powerless against higher harmonics except for its insulations threatened and cores overheated. Provided that only a few of passive components are added, it comes true that the conventional transformer will become one both transferring power from input to output and also functioning as harmonic isolation from between, i.e. a function of waveform conversion from square-wave to sinusoid being added, which was just a matter of regret, being long expected but not realized yet, in the past.

### SUMMERY OF THE INVENTION

Realizations of the present LC combined transformer of this invention can be divided into three fundamental categories or types according to their functional focuses: current conversion category/type (ideal current transformer), voltage conversion category/type (ideal voltage transformer) and, voltage and current conversion category/type (ideal transformer); besides, though to some extent, they all have the function of waveform conversion from square wave to quasi-sinusoid. Aiming at the imperfections of the widely-used transformer in practical engineering, the invention presents some improvements in principle employing the easiest passive-circuit design approaches to realize the optimum characteristics of current or/and voltage conversions that eliminate the reactive error in principle, optimize structural parameters so as to reduce real-power loss error to minimum, as well as limit non-linear errors of both the inductors and the mutual inductor. To ensure the realizations of their best features, this invention also details the needed specific device selections, linearization processing of inductors, and the integration design approach for the coils and magnetic cores of the inductor and the mutual inductor, not only to achieve in compensation of the errors comprehensively, but also in cost savings with the goal of small devices. The ideal current transformer designed by this invention is suited for sinusoidal current test; the ideal voltage transformer suited for voltage measurement; and being further updated can evolve them into both voltage convertible and current convertible, to realize power transferred with voltage and current in-phased, decreasing the ac line reactive current. The invention also introduces into the designs the new characteristic of waveform conversion from square-wave to quasi-sinusoid, by which the transformers for both waveform conversion (or waveform isolation) and power delivery can be designed, suitable for applications in power electronics, such as in dc transmission, the passive filtering of ac voltage or current, etc. Meanwhile, the usage of push-pull inductor, as well as the technique of the bi-periodically time-shared driving, is brought out, a solution to the problem of the core's unsymmetrical magnetization in double-ended converter under the alternately driving and also an improvement on the issue of cross-conductance of the driving switches.

### BRIEF DESCRIPTION OF THE DRAWINGS

The following drawings, which form an important part of this specification, aid to elaborate the presented invention in details:

FIG. 1 is a principle circuit symbol of a mutual inductor (or conventional transformer) and its equivalent circuit diagram expressed by using an ideal transformer.

FIG. 2 is the diagram of general circuitry arrangement of the LC combined transformer and those of its equivalent circuits for non-loss analysis and for loss analysis.

FIGS. 3(a) and (b) are diagrams of the equivalent circuits for non-loss analysis and for loss analysis of current conversion-A type of the LC combined transformer (Ideal Current Transformer A); (c) and (d) diagrams of the configurations employing the design approach of integrated inductor and mutual inductor.

FIGS. 4(a) and (b) are diagrams of the equivalent circuits for non-loss analysis and for loss analysis of current conversion-B type of the LC combined transformer (Ideal Current Transformer B).

FIG. 5 are diagrams of the equivalent circuits for non-loss analysis and for loss analysis of the in-phase mode of voltage conversion type of the LC combined transformer.

FIGS. 6(a), (b) and (c) are diagrams of the equivalent circuits for non-loss analysis and for loss analysis of the anti-phase mode of voltage conversion type of the LC combined transformer; (d) is that of its configuration employing the design approach of integrated inductor and mutual inductor; (e) is the simplest arrangement diagram when ωL_{b}−1/ωC_{b}=0; (f) is the arrangement diagram when ωL_{bx}=ωL_{b}−1/ωC_{b}>0; (g) is a diagram for (f) when the integration design approach of inductor and mutual inductor employed.

FIGS. 7(a) and (b) are duplicates of FIGS. 5(a) and (b); (c) is a diagram of their equivalent circuit expressed by employing an ideal transformer; (d) is for (c), when ωCₚ₂=1/ωLₚ₁, namely, Eq.(60) met, evolved into the equivalent circuit diagram of in-phase mode of voltage conversion type of the LC combined transformer.

FIGS. 8(a) and (b) are duplicates of FIGS. 6(a) and (b); (c) is a diagram of their equivalent circuit expressed by employing an ideal transformer and also of the trends or methods evolving to be an ideal transformer; (d) is in (c) with a compensation capacitor, like Cₚ, Cₚₐ or C_{pb} inserted in parallel connection to meet any of Eqs. (66), (67) and (68), the evolved equivalent circuit diagram of anti-phase mode of voltage and voltage conversion type of the LC combined transformer (ideal transformer); (e) and (f), respectively corresponding to FIGS. 6(f) and (g), are diagrams of the ideal transformer configuration.

FIG. 9(a) is a duplicate of FIG. 3(a); (b) is a diagram of its equivalent circuit expressed by employing an ideal transformer; (c) is in (b) with a compensation capacitor, Cₛₐ or C_{sb}, inserted in series connection to meet either Eqs. (72) or (73), the evolved equivalent circuit diagram of voltage and current conversion-A type of the LC combined transformer (Ideal Transformer A).

FIG. 10(a) is a duplicate of FIG. 4(a); (b) is a diagram of its equivalent circuit expressed by employing an ideal transformer; (c) is in (b) when n_{c}=k, namely Eq. (78) met, the evolved equivalent circuit diagram of voltage and current conversion-B type of the LC combined transformer (Ideal Transformer B).

FIG. 11(a) is the diagram of a principle and trial circuit using either FIG. 5 or FIG. 7 to implement the waveform conversion from square-wave to quasi-sinusoid; (b) is an improved version from (a) by employing the push-pull inductor; (c) are the control and driving signals used for transistor switches in (a) and (b); (d) is the hysteresis loop of the core of inductor Lₐ in (a) in steady-state operation; (e) is the hysteresis loop of the core of inductor Lₐ in (b) in steady-state operation.

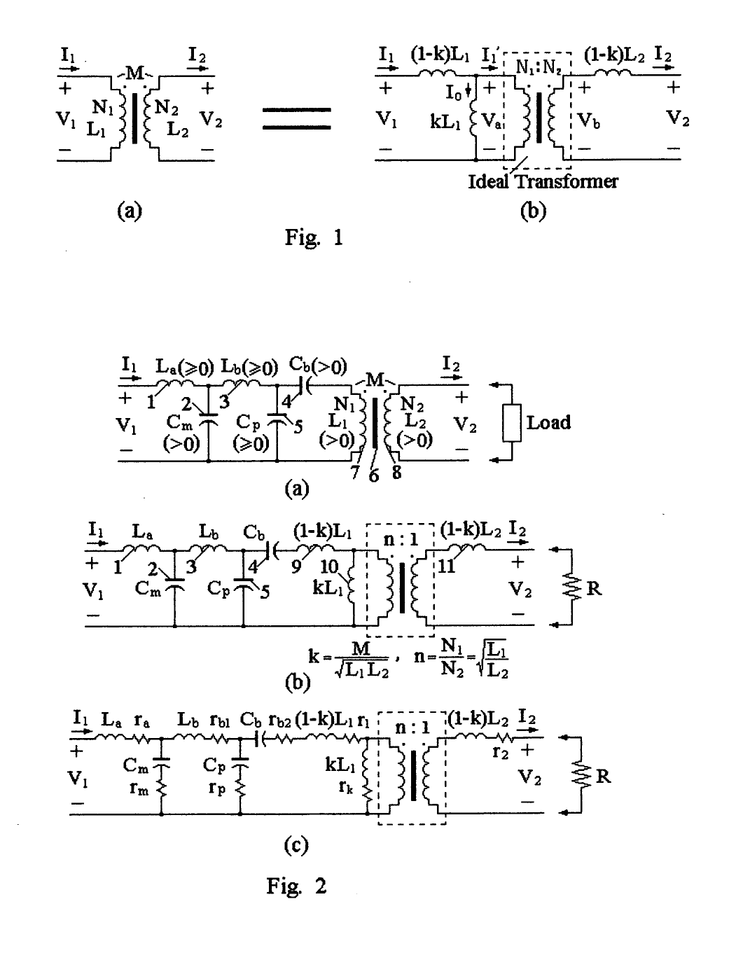

FIGS. IV-1˜IV-8 are illustrated drawings for Appendix IV “Principle of Mutual Capacitors”.

### DETAILED DESCRIPTION OF THE INVENTION

The general circuitry arrangement of the LC combined transformer is illustrated as in FIG. 2(a), with the load not included. Circuit components 1 and 3 are inductances Lₐ and L_{b}, with inductance value >0 meaning positive, and the value=0 meaning short-circuited. Circuit components 2, 4 and 5 are capacitances Cₘ, C_{b} and Cₚ, with capacitance value >0 meaning positive (including C→+∞, short-circuited), and the value=0 meaning open-circuited. 6 is the core magnetic circuit of the mutual inductor, 7 its primary winding N₁ (with inductance L₁>0), and 8 its secondary winding N₂ (with inductance L₂>0) and, 6,7 and 8 constitute a mutual inductor or conventional transformer. All the circuit components and the mutual inductor herein can be real devices, although their magnitudes or values may be worked out respectively by one or more components based on the principles of series-parallel connections, with their application equivalent for the definition herein, and with the corresponding power loss. Their electrically-interconnections are: One end of inductance 1 and one end of capacitance 2 are together connected to one end of inductor 3; the other end of 3, one end of capacitance 5, and one end of capacitance 4 connected to each other; and the other end of 4 connected to one end of the winding 7; and the other end of 7 connected to the other end of 5 and to the other end of 2, taken for the common terminal; designating the other end of 1 and the common terminal as the input port of the LC combined transformer, two terminals of the winding 8 as its output port; and with the stipulation that input and output ports herein can be designated at will when needed. Where capacitance 5 should be may be as it is seen herein, or equivalently moved if necessary to parallel with the input or output port. And when capacitance 5 moved away or open-circuited, the position of capacitance 4 may be interchanged with that of inductance 3, or equivalently moved to series with the input or output port owing to doing so with the circuitry function unchanged except for a different magnitude. The mutual inductor (or transformer) is a double-winding, and it can also be a multi-winding, as long as it can be theoretically converted to a double-winding mutual inductor and utilized within this invention. Any circuit designed out of the configurations of this invention must be working under the circumstance with a constant frequency ω (or f) of periodical sinusoidal wave or of a periodical wave at least unless in peculiar applications.

The technology scheme of this invention lies in that by utilization of the mutual inductor's leakage inductances (1−k )L₁ and (1−k )L₂ and the magnetization inductance kL₁, mated with externally connected capacitances or/and inductances, in accordance with the principle of the mutual capacitor [Note: refer to Appendix IV “Principle of Mutual Capacitors”], one or two cascaded mutual capacitors can be constructed with the function of ideal current or voltage conversion; and also cascading with the ideal transformer peeled off the leakage and magnetization inductances, an ideal current transformer, an ideal voltage transformer or an ideal transformer can eventually be achieved.

FIG. 2(b) is the diagram of equivalent circuit for non-loss analysis of FIG. 2(a), and FIG. 2(c) that for loss analysis. In order to make easier analysis and designs hereafter, let's assume that the LC combined transformer always has a resistive load, R. The arrangement of the specific circuit or variant of every type and mode of the LC combined transformer must be designed in accordance with its featured focuses or its main functions, while the main functions are to be determined by the employed LC unit system or module/block/subunit, named mutual capacitor.

The LC combined transformer, according to its functional focus, can be divided into three fundamental categories or types: current conversion category/type (ideal current transformer), voltage conversion category/type (ideal voltage transformer), and voltage and current conversion category/type (ideal transformer); The first type has two circuit arrangements of conversion-A type and conversion-B type, the latter two types include in-phase mode and anti-phase mode respectively, and the third type also includes conversion-A type and conversion-B type arrangements.

### 1. Current Conversion Type LC Combined Transformer (Ideal Current Transformer)

The Current conversion type of the LC combined transformer, or the ideal current transformer, has its main duties as performing sinusoidal current conversion, current monitoring and measuring or test for instruments, and it also can be designed for ac power delivery, as an ac constant-current generator, or apparatus for current waveform conversion or isolation from square wave to quasi-sinusoid as well.

### 1-1. Current Conversion-A Type LC Combined Transformer

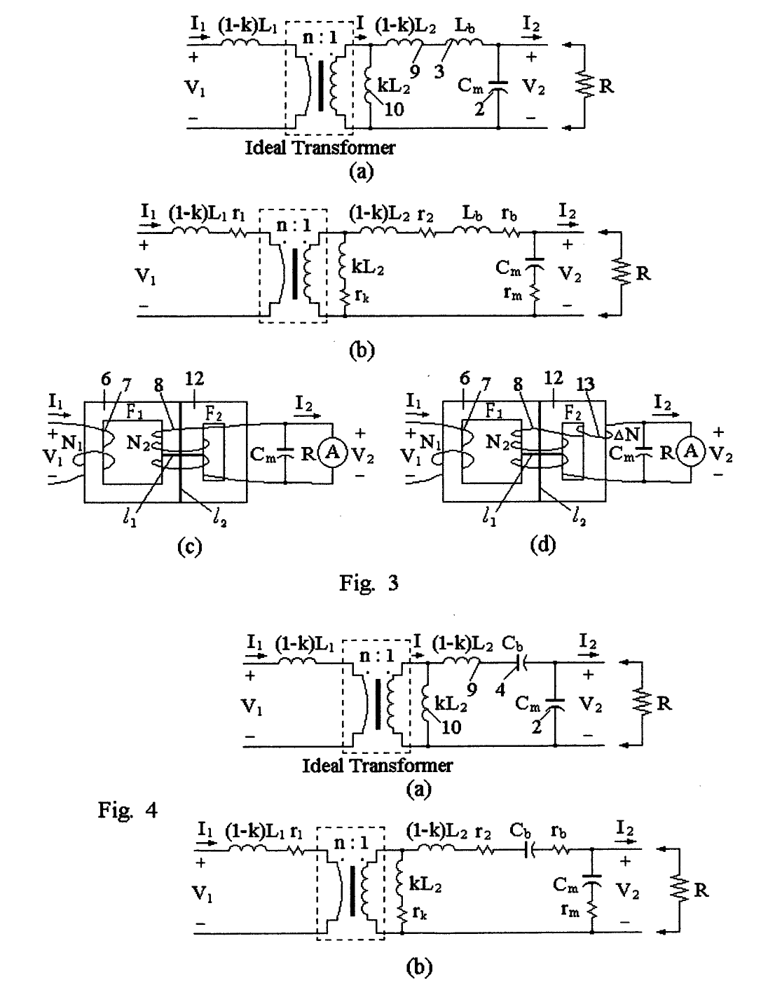

Herein details the design of the current conversion-A type LC combined transformer with V₂ side in FIG. 2 as input port and V₁ side as output. Therefore, in FIG. 2, take inductance 1 and capacitance 4 short-circuited (namely, Lₐ=rₐ=0, C_{b}→+∞, r_{b}=0), capacitance 5 open-circuited (Cₚ=0, rₚ→+∞), to obtain the analysis circuit diagram as in FIG. 3.

In FIG. 3(a), the transformer secondary magnetization inductance 10, leakage inductance 9, inductance 3, and capacitance 2 constitute an LC subunit/subsystem (called Δ or π mutual capacitor by the inventor). And the current ratio of this mutual capacitor can be calculated as

$${n}_{c} = \frac{I}{{I}_{2}} = \frac{1}{k} [ ( 1 + \frac{{L}_{b}}{{L}_{2}} ) + \frac{1 - {ω}^{2} {C}_{m} ( {L}_{2} + {L}_{b} )}{jω {L}_{2}} \cdot R ] \qquad ( 8 )$$

If component parameters are set to meet the condition ω²Cₘ(L₂+L_{b})=1 (9) the ratio will be

$${n}_{c} = \frac{I}{{I}_{2}} = \frac{1}{k} ( 1 + \frac{{L}_{b}}{{L}_{2}} ) \qquad ( 10 )$$

And the current ratio of the entire circuit in FIG. 3(a) will be

$$\frac{{I}_{1}}{{I}_{2}} = \frac{{I}_{1}}{I} \cdot \frac{I}{{I}_{2}} = \frac{1}{n} \cdot {n}_{c} = \frac{1}{nk} ( 1 + \frac{{L}_{b}}{{L}_{2}} ) \qquad ( 11 )$$

This result indicates that the circuit in FIG. 3, when the condition Eq. (9) met, is an ideal transformer of current conversion, called conversion-A ideal current transformer or ideal current transformer A, independent of both the working frequency ω and the load R. And the ratio is determined only by the selected values of the mutual inductor's turns ratio

$$( n = \frac{{N}_{1}}{{N}_{2}} = \sqrt{\frac{{L}_{1}}{{L}_{2}}} ) ,$$

the coupling coefficient

$$( k = \frac{M}{\sqrt{{L}_{1} {L}_{2}}} ) ,$$

the self-inductance L₂, and the series inductance L_{b}.

But, all the above conclusions are obtained in the ideal situation. As a matter of fact, the frequency of steady-state sinusoidal current is slightly undulate (for 60 Hz or 50 Hz line frequency has a relative error

$$\vert \frac{Δ f}{f} \vert = \vert \frac{Δ ω}{ω} \vert \leq 1 \% ) ;$$

capacitors have their values changeable with the waving ambient temperature; iron-cored inductors are of such a non-linearity that their inductance values are changeable with magnitudes of the current flowing through the coil windings therein (i.e. with the changes of operating points); in addition, wires, cores as well as capacitors in reality are power-dissipated (see FIG. 3(b)); which all would deviate the current ratio from Eq. (11). Here come the errors theoretically derived as follows:
The relative error of the current ratio on frequency change is

$${\vert \frac{Δ {n}_{c}}{{n}_{c}} \vert}_{ω} \approx 2 ω {C}_{m} R \cdot \vert \frac{Δ ω}{ω} \vert \qquad ( 12 )$$

The relative error of the current ratio on capacitance change is

$${\vert \frac{Δ {n}_{c}}{{n}_{c}} \vert}_{C} \approx ω {C}_{m} R \cdot \vert \frac{Δ C}{C} \vert \qquad ( 13 )$$

The relative error of the current ratio on relative permeability change of the core material is

$${\vert \frac{Δ {n}_{c}}{{n}_{c}} \vert}_{μ} \approx \frac{α ω {C}_{m} R}{α + {μ}_{r}} \cdot \vert \frac{Δ {μ}_{r}}{{μ}_{r}} \vert \qquad ( 14 )$$

where, α=l_{F}/l_{g} is the ratio of the core magnetic circuit length to the air-gap length; μᵣ the relative permeability of the inductors' core material. Moreover, the prerequisite for obtaining this equation is that inductors of L₂ and L_{b} are made of the same core material and of the same α value. The relative error of the current ratio on the devices' power-loss from FIG. 3(b) is

$${\vert \frac{Δ {n}_{c}}{{n}_{c}} \vert}_{r} \approx ( {r}_{2} + {r}_{b} + {r}_{k} + {r}_{m} ) {( ω {C}_{m} )}^{2} R \qquad ( 15 )$$

The prerequisite for obtaining this equation is that quality factors of the inductors of L₂ and L_{b} are equal and far greater than 1, i.e.

$$\frac{ω {L}_{2}}{{r}_{2} + {r}_{k}} = \frac{ω {L}_{b}}{{r}_{b}} >> 1 ;$$

and also that the loss tangent of capacitor Cₘ should be very small, or ωCₘrₘ=tg δ→0.

Design Key Points [Note: refer to Appendix I “Design Instructions of the LC Combined Transformer and General Rules for Its Device Selections”]: Attentions should be paid to error equations (12)˜(15) on that (ωCₘR) is a key parameter expression for designing errors of the mutual capacitor, called error-designed parameter expression of the mutual capacitor; if it is small the error will be small; meanwhile, Eq. (9) shows that the inductance value of (L₂+L_{b}) will be large so as to waste materials and increase sizes. Therefore, proper compromise will be needed in practical designing.

Device Selections: The criterion of device selections for conversion-A ideal current transformer is to meet the requests of above theoretical designing as far as possible, promoting the inherent features that properties of devices vary along with ambient or/and working conditions in materials, physical structures, as well as manufacture methods etc, namely promoting the linearity, and decreasing devices' power dissipation or reducing influence of devices' power-loss over operation.

Device selection of capacitor of Cₘ includes that a proper capacitance value should be determined according to the measuring accuracy or error request designed from (12)˜(15), and the right product be chosen according to the requests of, the range of ambient temperature change, working frequency, voltage grade, value precision grade and dielectric loss angle etc. In this case, due to Cₘ in parallel with the low-valued resistive load R (ammeter A) (see FIG. 3(c)), the objective of voltage grade is apt to be met, and the dielectric loss angle tangent, tg δ<10⁻³, of non-polar capacitors of most modern manufacturers is good enough for this application; then by Eq.(13), according to the determined value and the range of ambient temperature change, select the capacitor with appropriate dielectric material.

The values of parameters L_{b}, L₂, n and k of the serried inductor and the mutual inductor are to be determined from Eqs. (9)·(11), where the value k must be pre-determined accurately through experiment so as to reduce blindness in the follow-up designing.

Device selection of the mutual inductor and the serried inductor is a key step for designing in this case, including determination of the coil copper wires, core materials, physical structures and their production methods. The L₁ and L₂ of the mutual inductor must be of an identical core material with low-loss and high saturation magnetic flux density to that of the inductor L_{b}, together with precise calculation of the amount of copper and core to be used, managing to ensure the quality factors of L₂ and L_{b} to be equal and far greater than one, or

$$\frac{ω {L}_{2}}{{r}_{2} + {r}_{k}} = \frac{ω {L}_{b}}{{r}_{b}} >> 1.$$

Both the series inductor and the mutual inductor must be of a structure of core plus air-gap, which is referred to as linerization processing of inductors/mutual-inductors [Note: refer to Appendix II “Formulas for Linerization Processing of Inductors/Mutual-Inductors”], for air-gapped inductor is calculated as

$$\begin{matrix}{L}_{2} = \frac{{μ}_{0} {N}_{2}^{2} {S}_{2}}{{l}_{g 2} + {l}_{F 2} / {μ}_{r}} \\ = \frac{{μ}_{0} {N}_{2}^{2} {S}_{2}}{{l}_{g 2} [ 1 + ( {l}_{F 2} / {l}_{g 2} ) / {μ}_{r} ]} \\ = \frac{{μ}_{0} {N}_{2}^{2} {S}_{2}}{{l}_{g 2} [ 1 + {α}_{2} / {μ}_{r} ]} \\ = \frac{{μ}_{0} {N}_{2}^{2} {S}_{2}}{{l}_{F 2} [ ( {l}_{g 2} / {l}_{F 2} ) + 1 / {μ}_{r} ]} \\ = \frac{{μ}_{0} {N}_{2}^{2} {S}_{2}}{{l}_{F 2} [ 1 / {α}_{2} + 1 / {μ}_{r} ]}\end{matrix}$$

$$\begin{matrix}{L}_{b} = \frac{{μ}_{0} {N}_{b}^{2} {S}_{b}}{{l}_{g b} + {l}_{Fb} / {μ}_{r}} \\ = \frac{{μ}_{0} {N}_{b}^{2} {S}_{2}}{{l}_{gb} [ 1 + ( {l}_{Fb} / {l}_{gb} ) / {μ}_{r} ]} \\ = \frac{{μ}_{0} {N}_{b}^{2} {S}_{2}}{{l}_{ gb} [ 1 + {α}_{b} / {μ}_{r} ]} \\ = \frac{{μ}_{0} {N}_{b}^{2} {S}_{b}}{{l}_{Fb} [ ( {l}_{g b} / {l}_{Fb} ) + 1 / {μ}_{r} ]} \\ = \frac{{μ}_{0} {N}_{b}^{2} {S}_{b}}{{l}_{F 2} [ 1 / {α}_{b} + 1 / {μ}_{r} ]}\end{matrix}$$

where, l_{F} and l_{g} represent the core length and air-gap length respectively, and αᵢ=l_{Fi}/l_{gi} (i=2, b); Nᵢ is coil winding turns number; Sᵢ is core cross-sectional area. Assuming α=α₂=l_{F2}/l_{g2}=l_{Fb}/l_{gb}=α_{b}, and substitute above two formulas of L₂ and L_{b} into Eq. (11) as

$$\begin{matrix}\frac{{I}_{1}}{{I}_{2}} = \frac{1}{nk} ( 1 + \frac{{L}_{b}}{{L}_{2}} ) \\ = \frac{1}{nk} [ 1 + \frac{{l}_{g 2}}{{l}_{gb}} \cdot \frac{{S}_{b}}{{S}_{2}} {( \frac{{N}_{b}}{{N}_{2}} )}^{2} ] \\ = \frac{1}{nk} [ 1 + \frac{{l}_{F 2}}{{l}_{Fb}} \cdot \frac{{S}_{b}}{{S}_{2}} {( \frac{{N}_{b}}{{N}_{2}} )}^{2} ]\end{matrix} \qquad ( 16 )$$

Eq. (16) indicates that the current ratio of this LC combined transformer illustrated in FIG. 3 is absolutely determined by the structural parameters of L₁ and L₂ of the mutual inductor, and of L_{b} of the series inductor, theoretically independent of the value μᵣ of the core material; which is because the introduction of the air-gap, i.e. the linerization processing of inductors, causes the inductances much more stable, and also because of a principle of cancellation of similarity employed during the design and coil winding of inductors. The relative error of the final current ratio of the entire current transformer influenced by the change of relative permeability of core is obtained from Eq. (14).

### 1-2. Design Approach of Integrated Inductor and Mutual Inductor

FIGS. 3(c) and (d) are diagrams of the current conversion-A type LC combined transformer employing the design approach of integrated inductor and mutual inductor.

The integrated inductor and mutual-inductor includes: the mutual inductor's core magnetic circuit 6, the series inductor's core magnetic circuit 12, the mutual inductor's primary winding 7, the two-in-one common coil winding 8 which serves as both the mutual inductor's secondary winding and also the series inductor's winding, as well as the auxiliary winding 13. The magnetic circuits of the integrated inductor and mutual inductor may be made from any core material, with any possible shape and any cross-sectional areas, and also may be unequal in length to each other; but the ratios of both, of the core magnetic circuit length to the air-gap length respectively, should be equal or approximately equal. The mutual inductor's turn ratio, coupling coefficient, primary self-inductance, secondary self-inductance, and all the current and power relations are still determined as those of the conventional mutual inductor, but its output total inductance be determined, under the condition of the magnetic circuits with qualified linearity, by the sum of the mutual inductor's secondary self-inductance determined as a conventional mutual inductor plus the inductance determined by windings 8 and 13, and core 12 all together. In addition, to insure the magnetic circuits of a sound linearity, gaps or clearances l₁ and l₂ may be set as shown in FIG. 3(c).

The so-called integration design of the inductor and mutual inductor is actually having the cores of the series inductor and the mutual inductor integrated together, and also having their coil windings integrated together, as a result that they look like only one mutual inductor with a function of the mutual inductor plus the series inductor. Assuming N₂=N_{b}, that is

$$\begin{matrix}\frac{{I}_{1}}{{I}_{2}} = \frac{1}{nk} ( 1 + \frac{{L}_{b}}{{L}_{2}} ) \\ = \frac{1}{nk} [ 1 + \frac{{l}_{g 2}}{{l}_{gb}} \cdot \frac{{S}_{b}}{{S}_{2}} ] \\ = \frac{1}{nk} [ 1 + \frac{{l}_{F 2}}{{l}_{Fb}} \cdot \frac{{S}_{b}}{{S}_{2}} ]\end{matrix} \qquad ( 16 a )$$

which is the equation of the current ratio of the current conversion-A type LC combined transformer employing the design approach of integrated inductor and mutual inductor. From this equation, only k could be adjusted when n (=N₁/N₂), l_{F}, l_{g} and S are made fixed. However, the variation of k means changing the air-gap length, also meaning the condition of Eq. (9) spoiled. Now, assuming N_{b}=N₂+ΔN again and substituting it into Eq.(16), we have

$$\begin{matrix}\frac{{I}_{1}}{{I}_{2}} = \frac{1}{nk} ( 1 + \frac{{L}_{b}}{{L}_{2}} ) \\ = \frac{1}{nk} [ 1 + \frac{{l}_{g 2}}{{l}_{gb}} \cdot \frac{{S}_{b}}{{S}_{2}} ( 1 + \frac{Δ N}{{N}_{2}} ) ] \\ = \frac{1}{nk} [ 1 + \frac{{l}_{F 2}}{{l}_{Fb}} \cdot \frac{{S}_{b}}{{S}_{2}} ( 1 + \frac{Δ N}{{N}_{2}} ) ]\end{matrix} \qquad ( 16 b )$$

As seen in this equation, the variation of ΔN, i.e. changing turn number of the auxiliary winding, changes only the inductance of L_{b}, by which comes true the needed micro-adjustment, with the layout of the coil windings as in FIG. 3(d).

Like the design of every other product, the design of this product has to be improved through repeated experiments so finally to be as expected. Moreover, a suggestion is made, if possible, that the same kind of magnetic powder core material should be employed for the two pairs of cores of F₁ and F₂ illustrated as in FIG. 3(c) or (d); whose advantage is easy to have an equal α value for both.

It saves materials to design an LC combined transformer by employing the integration design of inductor and mutual inductor (a coil winding of L_{b} saved) so that the total size decreases because the air-gapped cores set the current transformer free from heavy burden of the balance of the magnetic potentials or ampere-turns, and meanwhile the requirements of the window areas of the cores and of the insulation grades decrease accordingly. However, these advantages can be brought into play only at high-current detections because a fixed LC value must be set, by Eq. (9), for the current conversion-A type LC combined transformer. It is also easy to notice from Eqs.(10) and (11) that the current conversion-A type LC combined transformer, as a matter of fact, performs two current conversions that 1/n is the first current conversion, namely the current ratio of the conventional current transformer, and the second is that of the mutual capacitor which is determined by Eq. (10), so that a very high rating of current conversion ratio could be achieved.

In the integrated inductor and mutual inductor (FIG. 3(c) or (d)), the function of a mutual inductor occurs between coil windings N₁ and N₂ while N₂ on its own functions as two inductances in series as

$${L}_{Total} = {L}_{F 1} + {L}_{F 2} = \frac{{μ}_{0} {N}_{2}^{2} {S}_{F 1}}{{l}_{g 1} {l}_{F 1} / {μ}_{r}} + \frac{{μ}_{0} {N}_{b}^{2} {S}_{F 2}}{{l}_{g 2} {l}_{F 2} / {μ}_{r}} \qquad ( 17 )$$

where, meanings of the symbols are the same as previous, and the subscripts in accordance with the core number F₁ and F₂ [Note: this equation is obtained under the condition of a good linearity]. And proof of this equation omitted.

### 1-3. Current Conversion-B Type LC Combined Transformer

The circuitry design of the current conversion-B type LC combined transformer is also presented as the formation with V₂ side in FIG. 2 as input port and V₁ side as output. In FIG. 2, make inductances 1 and 3 short-circuited (namely, Lₐ=rₐ=0, L_{b}=r_{b1}=0), capacitance 5 open-circuited (Cₚ=0, rₚ→+∞), to obtain the analysis circuit diagram as in FIG. 4.

In FIG. 4(a), the mutual inductor's secondary magnetization inductance 10, leakage inductance 9, capacitances 2 and 4 constitute an LC subunit/subsystem (called Δ or π mutual capacitor). And the current ratio of this mutual capacitor can be calculated as

$${n}_{c} = \frac{{I}_{1}}{{I}_{2}} = \frac{1}{k} \{ ( 1 - \frac{1}{{ω}^{2} {L}_{2} {C}_{b}} ) + j [ ω {C}_{m} - \frac{1}{ω {L}_{2}} ( 1 + \frac{{C}_{m}}{{C}_{b}} ) R ] \} \qquad ( 18 )$$

If component parameters are set to meet the condition

$$\begin{matrix}{ω}^{2} {L}_{2} ( {C}_{b} ⊥ {C}_{m} ) = {ω}^{2} {L}_{2} ( \frac{{C}_{b} {C}_{m}}{{C}_{b} + {C}_{m}} ) = 1 & ( 19 ) \\ then & \\ {n}_{c} = \frac{{I}_{1}}{{I}_{2}} = \frac{1}{k} ( 1 - \frac{1}{{ω}^{2} {L}_{2} {C}_{b}} ) = \frac{1}{{ω}^{2} {kL}_{2} {C}_{m}} = \frac{{C}_{b}}{k ( {C}_{b} + {C}_{m} )} & ( 20 )\end{matrix}$$

And notice that n_{c}<1 in most cases. Thus the current ratio of the entire circuit in FIG. 4(a) will be

$$\frac{{I}_{1}}{{I}_{2}} = \frac{{I}_{1}}{I} \cdot \frac{I}{{I}_{2}} = \frac{1}{n} \cdot {n}_{c} = \frac{{C}_{b}}{nk ( {C}_{b} + {C}_{m} )} \qquad ( 21 )$$

And this result denotes that the circuit in FIG. 4, when the condition Eq. (19) is met, is also an ideal transformer of current conversion, called the conversion-B ideal current transformer or ideal current transformer B, independent of both the working frequency ω and the load R. And the ratio is determined only by the selected values of the mutual inductor's turns ratio (n=N₁/N₂=\sqrt{L₁/L₂}), the coupling coefficient

$$( k = \frac{M}{\sqrt{{L}_{1} {L}_{2}}} ) ,$$

the series capacitance C_{b}, and the parallel capacitance Cₘ.

Here give the errors theoretically derived as follows: The relative error of the current ratio on frequency change is

$${\vert \frac{Δ {n}_{c}}{{n}_{c}} \vert}_{ω} \approx \sqrt{1 + {[ ω ( {C}_{b} + {C}_{m} ) R ]}^{2}} \cdot 2 \frac{{C}_{m}}{{C}_{b }} \cdot \vert \frac{Δ ω}{ω} \vert \qquad ( 22 )$$

The relative error of the current ratio on capacitance change is

$${\vert \frac{Δ {n}_{c}}{{n}_{c}} \vert}_{C} \approx \sqrt{1 + {[ ω ( {C}_{b} + {C}_{m} ) R ]}^{2}} \cdot \frac{{C}_{m}}{{C}_{b }} \cdot \vert \frac{Δ C}{C} \vert \qquad ( 23 )$$

The relative error of the current ratio on relative permeability change of the core material is

$${\vert \frac{Δ {n}_{c}}{{n}_{c}} \vert}_{μ} \approx \sqrt{1 + {[ ω ( {C}_{b} + {C}_{m} ) R ]}^{2}} \cdot \frac{{C}_{m}}{{C}_{b }} \cdot \frac{α}{α + {μ}_{r }} \vert \frac{Δ {μ}_{r}}{{μ}_{r}} \vert \qquad ( 24 )$$

where, α=l_{F}/l_{g} is the ratio of the core magnetic circuit length to the air-gap magnetic circuit length; μᵣ the relative permeability of the inductors' core material. Moreover, the prerequisite for obtaining this equation is that inductors of (1−k)L₂ and kL₂ are of the same α value. The relative error of the current ratio on the devices' power-loss obtained from FIG. 4(b) is

$${\vert \frac{Δ {n}_{c}}{{n}_{c}} \vert}_{r} \approx ( {r}_{2} + {r}_{b} + {r}_{k} + {r}_{m} ) {( ω {C}_{m} )}^{2} R \qquad ( 25 )$$

The prerequisite for obtaining this equation is that quality factor of the inductor L₂ is far greater than 1, i.e.

$$\frac{ω {L}_{2}}{{r}_{2} + {r}_{k}} >> 1 ;$$

and also that the loss tangent of capacitors C_{b} and Cₘ should be very small, that is ωC_{b}r_{b}=Cₘrₘ=tgδ→0.

Design Key Points [Note: see Appendix I “Design Instructions of the LC Combined Transformer and General Rules for Its Device Selections”]: Attentions should be paid to error equations (22)˜(25) on that

$$( \sqrt{1 + {[ ω ( {C}_{b} + {C}_{m} ) R ]}^{2}} \cdot \frac{{C}_{m}}{{C}_{b}} )$$

is the error-designed parameter expression of the mutual capacitor; when the values of

$$( {C}_{b} + {C}_{m} ) and \frac{{C}_{m}}{{C}_{b}}$$

set small the error will be very small; meanwhile, Eq. (19) shows that the inductance of L₂ will be large so as to waste materials and increase the sizes. Therefore, proper compromise will be needed in practical designing.

Device Selections: Device selections of capacitances C_{b} and Cₘ include proper determination of their values on designed measuring accuracy or error requirements, choosing the right products according to the requests of, the range of ambient temperature change, working frequency, voltage grade, value precision grade and dielectric loss angle etc, and characteristics of both capacitances changing with the environment expected as keeping in accordance. The request for the mutual capacitor is of a precise k value, L₂ with a good linearity, and low power loss.

### 2. Voltage Conversion Type LC Combined Transformer (Ideal Voltage Transformer)

The voltage conversion type of the LC combined transformer, or the ideal voltage transformer, has its main usages of performing sinusoidal voltage conversion, voltage monitoring and measuring/test for instruments; and it also can be designed for ac power delivery, or as an apparatus for voltage waveform conversion or isolation from square-wave to quasi-sinusoid as well. The voltage conversion type of the LC combined transformer includes two realizations of circuit arrangements of in-phase mode and anti-phase mode.

### 2-1. In-Phase Mode of the Voltage Conversion Type LC Combined Transformer

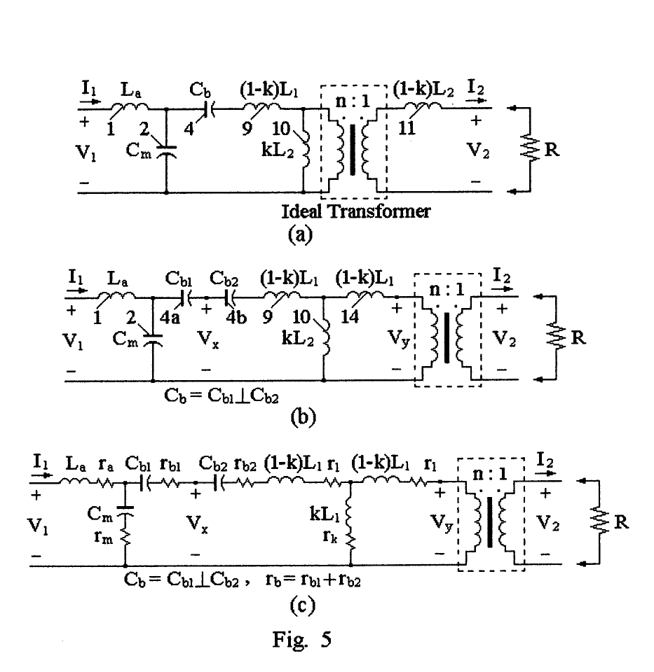

In the circuit diagram of FIG. 2, let inductance 3 short-circuited (i.e. L_{b}=r_{b1}=0), capacitance 5 open-circuited (i.e. Cₚ=0, rₚ→+∞) to obtain the in-phase mode of the voltage conversion type LC combined transformer illustrated in FIG. 5(a). In order to analyze it, let's split capacitance 4 into capacitances 4a and 4b (namely, C_{b} splited into C_{b1} and C_{b2} and

$${C}_{b} = {C}_{b 1} ⊥ {C}_{b 1} = \frac{{C}_{b 1} {C}_{b 2}}{{C}_{b 1} + {C}_{b 2}} ) ,$$

and equivalently reflect the leakage inductance 11 on the right side of the mutual inductor onto the left side as inductance 14, shown as in FIG. 5(b); where inductance 1, capacitances 2 and 4a constitute the first LC subunit/subsystem (T or Y mutual capacitor); capacitance 4b, two leakage inductances 9 and 14 of the mutual inductor, and its magnetization inductance 10 constitute the second; and the third part is the ideal transformer enclosed in the broken-line box.

For the first T mutual capacitor, assuming that it has an equivalent load of resistance R₁, its voltage ratio will be

$${n}_{v 1} = \frac{{V}_{1}}{{V}_{x}} = ( \begin{matrix}1 - \\ {ω}^{2} {L}_{a} {C}_{m}\end{matrix} ) + \frac{1}{j ω {C}_{b 1}} [ 1 - {ω}^{2} {L}_{a} ( {C}_{b 1} + {C}_{m} ) ] \frac{1}{{R}_{1}} \qquad ( 26 )$$

If setting the component parameters to meet the condition ω²Lₐ(C_{b1}+Cₘ)=1 (27) we have

$${n}_{v 1} = 1 - {ω}^{2} {L}_{a} {C}_{m} = \frac{{C}_{b 1}}{{C}_{b 1} + {C}_{m}} \qquad ( 28 )$$

Then, the relative error of the voltage ratio on frequency change is

$${\vert \frac{Δ {n}_{v 1}}{{n}_{v 1}} \vert}_{ω} \approx \sqrt{1 + {( \frac{1}{ω {n}_{v 1} {C}_{m} {R}_{1}} )}^{2}} \cdot 2 \vert ( \frac{1}{{n}_{v 1}} - 1 ) \frac{Δω}{ω} \vert \qquad ( 29 )$$

The relative error of the voltage ratio on capacitance change is

$${\vert \frac{Δ {n}_{v 1}}{{n}_{v 1}} \vert}_{C} \approx \sqrt{1 + {( \frac{1}{ω {n}_{v 1} {C}_{m} {R}_{1}} )}^{2}} \cdot \vert ( \frac{1}{{n}_{v 1}} - 1 ) \frac{Δ {C}_{m}}{{C}_{m}} \vert ; \\ ( when \vert \frac{Δ {C}_{b 1}}{{C}_{b 1}} \vert = \vert \frac{Δ {C}_{m}}{{C}_{m}} \vert ) \qquad ( 30 )$$

The relative error of the voltage ratio on relative permeability change of the core material is

$${\vert \frac{Δ {n}_{v 1}}{{n}_{v 1}} \vert}_{µ} \approx \sqrt{1 + {( \frac{1}{ω {n}_{v 1} {C}_{m} {R}_{1}} )}^{2}} \cdot \frac{α}{( α + {μ}_{r} )} \vert ( \frac{1}{{n}_{v 1}} - 1 ) \frac{{Δμ}_{r}}{{μ}_{r}} \vert \qquad ( 31 )$$

where, α=l_{F}/l_{g} is the ratio of the core magnetic circuit length to the air-gap magnetic circuit length; μᵣ the relative permeability of the inductors' core material.

The relative error of the current ratio on the devices' power-loss obtained from FIG. 5(c) is

$${\vert \frac{Δ {n}_{v 1}}{{n}_{v 1}} \vert}_{r} \approx \frac{{r}_{a}}{{n}_{v 1}^{2} {R}_{1}} \qquad ( 32 )$$

The prerequisite for meeting Eq. (32) is that the loss angle tangents of capacitances C_{b1} and Cₘ are equal or approximately equal, that is tg δ_{b1}=ωC_{b1}r_{b1}≈ωCₘrₘ=tg δₘ, as well as tg δ→0.

Also, it is noted that, when output power of this mutual capacitor is P,

$${R}_{1} = \frac{{V}_{x}^{2}}{P} = \frac{{V}_{1}^{2}}{{n}_{v 1}^{2} P} \qquad ( 33 )$$

Design Key Points [Note: see Appendix I “Design Instructions of the LC Combined Transformer and General Rules for Its Device Selections”]: From the error equations,

$$\sqrt{1 + {( \frac{1}{ω {n}_{v 1} {C}_{m} {R}_{1}} )}^{2}} \cdot ( \frac{1}{{n}_{v 1}} - 1 )$$

will be found out as the error-designed parameter expression of this mutual capacitor; if the value of (ωCₘR₁) set large the error will be small, but its capacity of load carrying will be limited; to improve which there exist some ways, increasing the value of Cₘ or/and ω.

Device Selections: Device selections of capacitances require the value precision grade and their temperature coefficient taken as high as possible based on the requirements of design. The temperature coefficients of C_{b1} and Cₘ are needed to be in accordance, and the loss angle tangents should be equal or approximately equal, that is tg δ_{b1}=ωC_{b1}r_{b1}≈ωCₘrₘ=tg δₘ, as well as tg δ→0. Meanwhile, the maximum voltages on the capacitances C_{b1} and Cₘ are calculated as the following equations (assuming the mutual capacitor's maximum load as R₁ₘ).

$$\begin{matrix}{U}_{b 1 max} \geq \frac{2 {V}_{x}}{ω {C}_{b 1} {R}_{1 m}} = \frac{2 V}{ω {C}_{b 1} {n}_{v 1} {R}_{1 m}} = \frac{2 {V}_{1} ( 1 - {n}_{v 1} )}{ω {C}_{m} {n}_{v 1}^{2} {R}_{1 m}} & ( 34 ) \\ \begin{matrix}{U}_{m max} \geq 2 {V}_{x} \sqrt{1 + {( \frac{1}{ω {C}_{b 1} {R}_{1 m}} )}^{2}} = \frac{2 {V}_{1}}{{n}_{v 1}} \sqrt{1 + {( \frac{1}{ω {C}_{b 1} {R}_{1 m}} )}^{2}} \\ = \frac{2 {V}_{1}}{{n}_{v 1}} \sqrt{1 + {( \frac{1 - {n}_{v 1}}{ω {C}_{m} {n}_{v 1} {R}_{1 m}} )}^{2}}\end{matrix} & ( 35 )\end{matrix}$$

The core of inductance Lₐ should be selected of a low-loss core material, with its magnetic circuit length ratio α of the iron core to the air gap chosen by Eq. (31) to meet the design requirements and also according to the material specifications.

Assume R₂ as the equivalent load of resistance for the second mutual capacitor; its voltage ratio is

$${n}_{v 2} = \frac{{V}_{x}}{{V}_{y}} = \frac{1}{k} [ ( 1 - \frac{1}{{ω}^{2} {L}_{1} {C}_{b 2 }} ) + \frac{1 - {ω}^{2} ( 1 - {k}^{2} ) {L}_{1} {C}_{b 2}}{jω {C}_{b 2} \cdot {R}_{2}} ] \qquad ( 36 )$$

If setting the component parameters to meet the condition ω²(1−k²)L₁C_{b2}=1 (37) we have

$${n}_{v 2} = \frac{{V}_{x}}{{V}_{y}} = \frac{1}{k} ( 1 - \frac{1}{{ω}^{2} {L}_{1} {C}_{b 2}} ) = k \qquad ( 38 )$$

The relative error of the voltage ratio on frequency change is

$${\vert \frac{Δ {n}_{v 2}}{{n}_{v 2}} \vert}_{ω} \approx \sqrt{1 + {( \frac{ω {L}_{1}}{{R}_{2}} )}^{2}} \cdot 2 ( \frac{1}{{k}^{2}} - 1 ) \vert \frac{Δω}{ω} \vert \qquad ( 39 )$$

The relative error of the voltage ratio on capacitance change is

$${\vert \frac{Δ {n}_{v 2}}{{n}_{v 2}} \vert}_{C} \approx \sqrt{1 + {( \frac{ω {L}_{1}}{{R}_{2}} )}^{2}} \cdot ( \frac{1}{{k}^{2}} - 1 ) \vert \frac{Δ {C}_{b 2}}{{C}_{b 2}} \vert \qquad ( 40 )$$

The relative error of the voltage ratio on relative permeability change of the core material is

$${\vert \frac{Δ {n}_{v 2}}{{n}_{v 2}} \vert}_{μ} \approx \sqrt{1 + {( \frac{ω {L}_{1}}{{R}_{2}} )}^{2}} \cdot ( \frac{1}{{k}^{2}} - 1 ) \frac{α}{( α + {μ}_{r} )} \vert \frac{{Δμ}_{r}}{{μ}_{r}} \vert \qquad ( 41 )$$

where, α=l_{F}/l_{g} is the ratio of the core magnetic circuit length to the air-gap magnetic circuit length; μᵣ the relative permeability of the inductors' core material.

The relative error of the current ratio on the devices' power-loss obtained from FIG. 5(c) is

$${\vert \frac{Δ {n}_{v 2}}{{n}_{v 2}} \vert}_{r} \approx \frac{{r}_{b 2} + {r}_{1} ( k + 1 )}{{k}^{2} {R}_{2}} \qquad ( 42 )$$

The prerequisite for Eq. (42) is that the quality factors of inductances (1−k)L₁ and kL₁ are equal. Design Key Points [Note: refer to Appendix I “Design Instructions of the LC Combined Transformer and General Rules for Its Device Selections”]: The error-designed parameter expression of this mutual capacitor is

$$\sqrt{1 + {( \frac{ω {L}_{1}}{{R}_{2}} )}^{2}} \cdot ( \frac{1}{{k}^{2}} - 1 ) ;$$

which denotes that, to minimize the error, the value of

$$( \frac{ω {L}_{1}}{{R}_{2}} )$$

should be as small as possible, and the k value as large as possible.

Device Selections: Device selection for capacitance C_{b2} is the same as that for C_{b1}, because they will be merged together as one in the end, and the maximum voltage on C_{b2} is calculated as follows

$${U}_{b 2 max} = ω ( 1 - {k}^{2} ) {L}_{1} \cdot \frac{{n}_{v 1} P}{{V}_{1}} = ω ( \frac{1}{k} - k ) {L}_{1} \cdot \frac{P}{{nV}_{2}} \qquad ( 43 )$$

The core material for L₁ or the mutual inductor should be selected, from Eqs. (41) and (42), of a high permeability and low core loss material. The prerequisite for Eq. (42) is that the quality factors of inductances (1−k)L₁ and kL₁ are equal, or [ω(1−k)L_{1]/r}₁=kL₁/rₖ, which is not easy to get into practice because r₁ is mainly the copper loss while rₖ is mainly iron loss. Try to decrease the difference between both as far as possible so as to be more accurate to estimate error by Eq. (42).

Now from Eqs. (28) and (38) as well as the ideal transformer's ratio n, the voltage ratio of entire in-phase mode of the voltage conversion type LC combined transformer will have the equation as

$${n}_{v} = \frac{{V}_{1}}{{V}_{2}} = \frac{{V}_{1}}{{V}_{x}} \cdot \frac{{V}_{x}}{{V}_{y}} \cdot \frac{{V}_{y}}{{V}_{2}} = {n}_{v 1} \cdot {n}_{v 2} \cdot n = {knn}_{v 1} = \frac{{knC}_{b 1}}{{C}_{b 1} + {C}_{m}} \qquad ( 44 )$$

Eq. (44) indicates that the circuit illustrated in FIG. 5, under the conditions of above discussed, is an ideal voltage transformer independent of the working frequency ω and the load R. It also shows that polarities of voltage conversion of V₁ and V₂ are in-phased, therefore, called the in-phase mode of the voltage conversion type LC combined transformer or in-phased ideal voltage transformer.

### 2-2. Anti-Phase Mode of the Voltage Conversion Type LC Combined Transformer

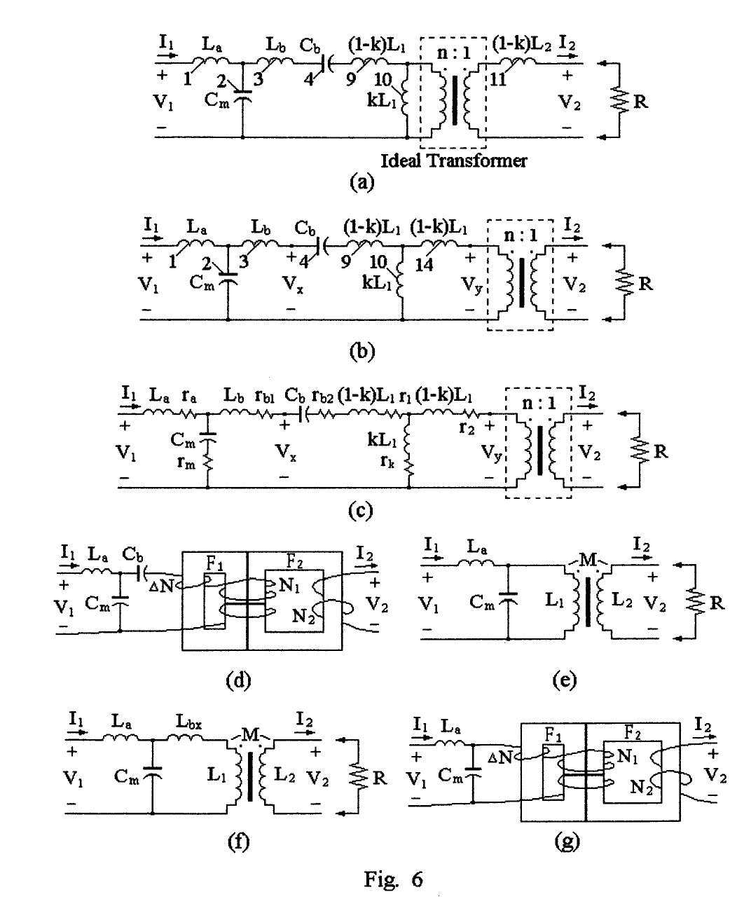

In FIG. 2, let capacitance 5 open-circuited (i.e. Cₚ=0, rₚ→+∞), though not excluding a round-off design of having capacitance 4 shot-circuited (i.e. C_{b}→+∞, r_{b2}=0), to obtain the anti-phase mode of the voltage conversion type LC combined transformer illustrated in FIG. 6(a). Imitating what's done for the in-phase mode, equivalently reflect the leakage inductance 11 on the right side of the mutual inductor onto the left side as inductance 14, shown as in FIG. 6(b); where inductances 1 and 3, plus capacitance 2 constitute the first LC subunit/subsystem (T or Y mutual capacitor); capacitance 4, the leakage inductances 9 and 14 of the mutual inductor, and its magnetization inductance 10 constitute the second LC subunit/subsystem (T or Y mutual capacitor); and the third part is the ideal transformer enclosed in the broken-line box.

Still, assume that the first T mutual capacitor has an equivalent load of resistance R₁, then the voltage ratio will be

$${n}_{v 1} = \frac{{V}_{1}}{{V}_{x}} = ( 1 - {ω}^{2} {L}_{a} {C}_{m} ) + jω ( {L}_{a} + {L}_{b} - {ω}^{2} {L}_{a} {L}_{b} {C}_{m} ) \frac{1}{{R}_{1}} \qquad ( 45 )$$

If setting component parameters to meet condition

$${ω}^{2} {C}_{m} = ( \frac{{L}_{a} {L}_{b}}{{L}_{a} + {L}_{b}} ) = {ω}^{2} {C}_{m} ( {L}_{a} // {L}_{b} ) = 1 \qquad ( 46 )$$

we have

$${n}_{v 1} = 1 - {ω}^{2} {L}_{a} {C}_{m} = - \frac{{L}_{a}}{{L}_{b}} \qquad ( 47 )$$

Thus, the relative error of the voltage ratio on frequency change is

$${\vert \frac{Δ {n}_{v 1}}{{n}_{v 1}} \vert}_{ω} \approx \sqrt{1 + {( \frac{{n}_{v 1} - 1}{ω {n}_{v 1} {C}_{m} {R}_{1}} )}^{2}} \cdot 2 \vert ( 1 - \frac{1}{{n}_{v 1}} ) \frac{Δω}{ω} \vert \qquad ( 48 )$$

The relative error of the voltage ratio on capacitance change is

$${\vert \frac{Δ {n}_{v 1}}{{n}_{v 1}} \vert}_{C} \approx \sqrt{1 + {( \frac{{n}_{v 1} - 1}{ω {n}_{v 1} {C}_{m} {R}_{1}} )}^{2}} \cdot \vert ( 1 - \frac{1}{{n}_{v 1}} ) \frac{Δ {C}_{m}}{{C}_{m}} \vert \qquad ( 49 )$$

The relative error of the voltage ratio on relative permeability change of the core material is

$${\vert \frac{Δ {n}_{v 1}}{{n}_{v 1}} \vert}_{μ} \approx \sqrt{1 + {( \frac{{n}_{v 1} - 1}{ω {n}_{v 1} {C}_{m} {R}_{1}} )}^{2}} \cdot \frac{α}{( α + {μ}_{r} )} \vert ( 1 - \frac{1}{{n}_{v 1}} ) \frac{{Δμ}_{r}}{{μ}_{r}} \vert \qquad ( 50 )$$

where, α=l_{F}/l_{g} is the ratio of the core magnetic circuit length to the air-gap magnetic circuit length; μᵣ the relative permeability of the inductors' core material. And the prerequisite for obtaining Eq. (50) is that Lₐ and L_{b} have cores of the same material and also of the same α value. The relative error of the current ratio on the devices' power-loss obtained from FIG. 6(c) is

$${\vert \frac{Δ {n}_{v 1}}{{n}_{v 1}} \vert}_{r} \approx \frac{2 ( 1 - {n}_{v 1} ) {r}_{b}}{{R}_{1}} \qquad ( 51 )$$

The prerequisite for Eq. (51) is that the quality factors or Q-values of inductances Lₐ and L_{b} should be equal, that is ωLₐ/rₐ=ωL_{b}/r_{b}=Q, as well as rₘ=rₐ//r_{b} be managed to achieve. Besides, the value of R₁ still could be worked out by Eq. (33).

Design Key Points [Note: refer to Appendix I “Design Instructions of the LC Combined Transformer and General Rules for Its Device Selections”]: This mutual capacitor has an error-designed parameter expression as

$$\sqrt{1 + {( \frac{{n}_{v 1} - 1}{ω {n}_{v 1} {C}_{m} {R}_{1}} )}^{2}} \cdot \vert 1 - \frac{1}{{n}_{v 1}} \vert ,$$

which shows that, to have a small error, the values of Cₘ and nᵥ₁ have to be large. In addition, if the positions of L_{b} and C_{b} switch to each other in the circuit, circuit function stays unchanged so that L_{b} and the mutual inductor could be constructed as an integrated inductor and mutual inductor as schematically illustrated in FIG. 6(d). Device Selections: Device selection of capacitance Cₘ requires the value precision grade and the temperature coefficient taken as high as possible based on the requests of design. The maximum voltage on Cₘ will be determined as

$${U}_{m max} \geq 2 {V}_{x} \sqrt{1 - {( \frac{ω {L}_{b}}{{R}_{1}} )}^{2}} = \frac{2 {V}_{1}}{{n}_{v 1}} \sqrt{1 + {( \frac{ω {L}_{b}}{{R}_{1}} )}^{2}} \qquad ( 52 )$$

Moreover, Eq. (51) requires that Cₘ's equivalent series resistance, rₘ=rₐ//r_{b}, to which a solution is to insert a proper resistance connected in series with it, with the only concerning that you should weigh and balance the necessity of paying a price of power dissipation. Inductors of Lₐ and L_{b} are selected as stated before, with the requests of the same a value and of the same Q-value.

The second subunit is the same as that in the in-phase mode [Note: but now in FIG. 6, C_{b} must take the place of C_{b2} in FIG. 5]. Thus, borrow the result from that as is in the in-phase mode and obtain the voltage ratio of the anti-phase mode of the voltage conversion type LC combined transformer as

$${n}_{v} = \frac{{V}_{1}}{{V}_{2}} = \frac{{V}_{1}}{{V}_{x}} \cdot \frac{{V}_{x}}{{V}_{y}} \cdot \frac{{V}_{y}}{{V}_{2}} = {n}_{v 1} \cdot {n}_{v 2} \cdot n = {knn}_{v 1} = - kn \frac{{L}_{a}}{{L}_{b}} \qquad ( 53 )$$

This equation indicates that the circuit illustrated in FIG. 6, when satisfying the conditions of above assumed, is also an ideal voltage transformer, with the polarities of voltages of input and output anti-phased, which is why, called the anti-phase mode of the voltage conversion type LC combined transformer or anti-phased ideal voltage transformer.

If one more step further, make

$$ω {L}_{b} - \frac{1}{ω {C}_{b}} = 0$$

in FIGS. 6(a) and (b); from Eqs. (37), (46) and (47), to get the following L_{b}=(1−k^{2)L}₁ (54) and

ω²Cₘ(1−k²)L₁=1+1/|nᵥ₁| (55)

Hence the circuit has its simplified arrangement (see FIG. 6(e)). Similarly, once more assume

$$ω {L}_{bx} = ω {L}_{b} - \frac{1}{ω {C}_{b}} > 0 , i . e . when \\ {L}_{bx} = {L}_{b} - \frac{1}{{ω}^{2} {C}_{b}} = {L}_{b} - ( 1 - {k}^{2} ) {L}_{1} > 0 \qquad ( 56 )$$

the circuit could leave out C_{b} as in FIG. 6(f) as well as in FIG. 6(g) by the integration design of inductor and mutual inductor.

### 3. Voltage and Current Conversion Type LC Combined Transformer (Ideal Transformer)

The voltage and current conversion type of the LC combined transformer, or the ideal transformer, is actually the technological extension expanded either from the voltage conversion type LC combined transformer to the current conversion type, or from the current conversion type LC combined transformer to the voltage conversion type. Accordingly, for the former there exist two configurations of circuitry designs of in-phase mode and anti-phase mode; while for the latter there also exist two circuitry realizations of conversion-A type and conversion-B type.

### 3-1. In-Phase Mode of the Voltage and Current Conversion Type LC Combined Transformer

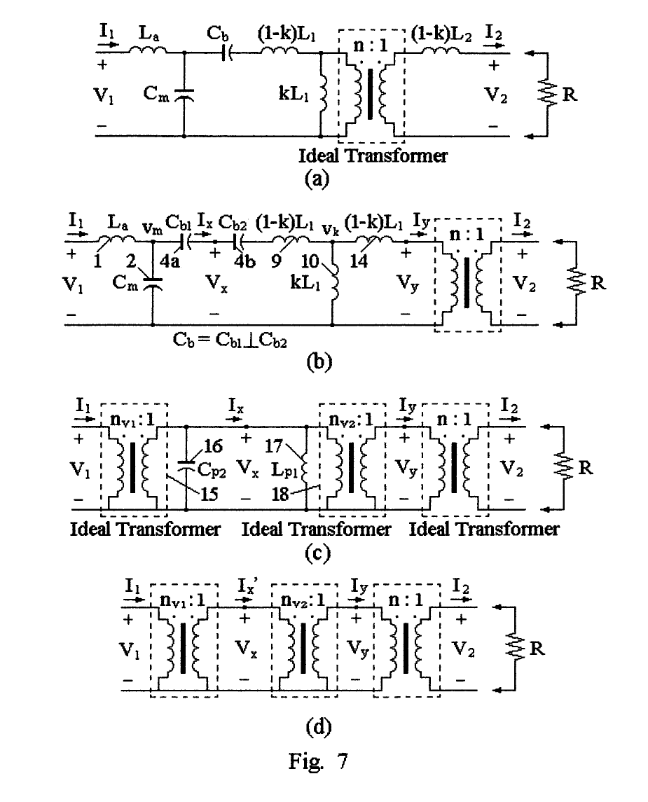

Firstly review the in-phase mode of the voltage conversion type LC combined transformer and redraw the circuit diagrams in FIGS. 5(a) and (b) as in FIGS. 7(a) and (b). In FIG. 7(b), of the first T mutual capacitor consisting of inductance 1, capacitances 2 and 4a, currents

$$\begin{matrix}\begin{matrix}{I}_{1} = \frac{{V}_{1} - {v}_{m}}{j ω {L}_{a}} \\ = \frac{{V}_{1} - {V}_{x}}{j ω {L}_{a}} - \frac{( {v}_{m} - {V}_{x} ) j ω {C}_{b 1}}{j ω {L}_{a} \cdot j ω {C}_{b 1}} \\ = ( 1 - \frac{1}{{n}_{v}} ) \frac{{V}_{1}}{j ω {L}_{a}} + \frac{{I}_{x}}{{ω}^{2} {L}_{a} {C}_{b 1}} \\ = j ω ( \frac{{C}_{m}}{{n}_{v 1}} ) {V}_{1} + \frac{1}{{n}_{v 1}} {I}_{x} \\ j ω {C}_{p 1} {V}_{1} + \frac{1}{{n}_{v 1}} {I}_{x} , ( {C}_{p 1} = \frac{{C}_{m}}{{n}_{v 1}} )\end{matrix} & ( 57 ) \\ \begin{matrix}{I}_{x} = {n}_{v 1} {I}_{1} - j ω {C}_{m} {V}_{1} \\ = {n}_{v 1} {I}_{1} - j ω ( {n}_{v 1} {C}_{m} ) {V}_{2} \\ = {n}_{v 1} {I}_{1} - j ω {C}_{p 2} {V}_{2} , ( {C}_{p 2} = {n}_{v 1} {C}_{m} )\end{matrix} & ( 58 )\end{matrix}$$

From Eqs. (28) and (58), an equivalent circuit, between V₁ and Vₓ in FIG. 7(c), of the ideal transformer 15 and its secondary-side paralleled capacitance 16 or Cₚ₂ is evolved. In the same way, of the second T mutual capacitor consisting of capacitance 4b, the mutual inductor's two leakage inductances 9 and 14, and also the magnetization inductance 10, there is an current as

$$\begin{matrix}{I}_{x} = \frac{{V}_{x} - {v}_{k}}{j ω ( 1 - k ) {L}_{1} + \frac{1}{j ω {C}_{b 2}}} \\ = \frac{{V}_{x} - {V}_{y}}{j ω ( 1 - k ) {L}_{1} + \frac{1}{j ω {C}_{b 2}}} - \\ \frac{( {v}_{k} - {V}_{y} )}{j ω ( 1 - k ) {L}_{1} [ 1 - \frac{1}{{ω}^{2} {C}_{b 2} ( 1 - k ) {L}_{1}} ]} \\ = ( 1 - \frac{1}{{n}_{v 2}} ) \frac{{V}_{x}}{j ω ( 1 - k ) {L}_{1} [ 1 - \frac{1}{{ω}^{2} {C}_{b 2} ( 1 - k ) {L}_{1}} ]} + \frac{1}{{n}_{v 2}} {I}_{y} \\ = \frac{{V}_{x}}{j ω ( {n}_{v 2} \cdot {kL}_{1} )} + \frac{1}{{n}_{v 2}} {I}_{y} \\ = \frac{{V}_{x}}{j ω {L}_{p 1}} + \frac{1}{{n}_{v 2}} {I}_{y} , ( {L}_{p 1} = {n}_{v 2} \cdot {kL}_{1} = {k}^{2} {L}_{1} )\end{matrix} \qquad ( 59 )$$

From Eqs. (38) and (59), achieve the equivalent circuit of inductance 17 in parallel with the primary of the ideal transformer 18, evolved from that between Vₓ and V_{y} in FIG. 7(b). Then, assume that the component parameters satisfying the condition ωCₚ₂=1/ωLₚ₁, i.e.

$$\begin{matrix}{ω}^{2} {C}_{p 2} {L}_{p 1} = {ω}^{2} {n}_{v 1} {C}_{m} {k}^{2} {L}_{1} \\ = {ω}^{2} ( 1 - {n}_{v 1} ) {C}_{b 1} {k}^{2} {L}_{1} \\ = {ω}^{2} \frac{{C}_{b 1} {C}_{m}}{{C}_{b 1} + {C}_{m}} {k}^{2} {L}_{1} \\ = {ω}^{2} {k}^{2} {L}_{1} ( {C}_{b 1} ⊥ {C}_{m} ) \\ = 1\end{matrix} \qquad ( 60 )$$

and notice Eq. (27) and C_{b}=C_{b1}⊥C_{b2}, we achieve that, when

$${ω}^{2} {L}_{1} ( \frac{{C}_{b} {C}_{m}}{{C}_{b} + {C}_{m}} ) = {ω}^{2} {L}_{1} ( {C}_{b} ⊥ {C}_{m} ) = 1 , \\ ( {C}_{b} = \frac{{C}_{b 1} {C}_{m}}{( {C}_{b 1} + {C}_{m} ) / {k}^{2} - {C}_{b 1}} ) \qquad ( 61 )$$

FIG. 7(c) is in circuitry equalized as FIG. 7(d) with its voltage and current equations as

$$\{ \begin{matrix}\frac{{V}_{1}}{{V}_{2}} = \begin{matrix}\frac{{V}_{1}}{{V}_{x}} \cdot \\ \frac{{V}_{x}}{{V}_{y}} \cdot \frac{{V}_{y}}{{V}_{2}}\end{matrix} = \begin{matrix}{n}_{v 1} \cdot \\ {n}_{v 2} \cdot n\end{matrix} = {n}_{v} = \frac{{nkC}_{b 1}}{{C}_{b 1} + {C}_{m}} = \begin{matrix}\frac{n}{k} \cdot \\ \frac{{C}_{b}}{{C}_{b} + {C}_{m}}\end{matrix} & ( 62 ) \\ \frac{{I}_{1}}{{I}_{2}} = \begin{matrix}\frac{{I}_{1}}{{I}_{x}^{\cdot }} \cdot \\ \frac{{I}_{x}^{\cdot }}{{I}_{y}} \cdot \frac{{I}_{y}}{{I}_{2}}\end{matrix} = \begin{matrix}\frac{1}{{n}_{v 1}} \cdot \\ \frac{1}{{n}_{v 2}} \cdot \frac{1}{n}\end{matrix} = \frac{1}{{n}_{v}} = \frac{\begin{matrix}{C}_{b 1} + \\ {C}_{m}\end{matrix}}{{nkC}_{b 1}} = \frac{k}{n} ( \begin{matrix}1 + \\ \frac{{C}_{m}}{{C}_{b}}\end{matrix} ) & ( 63 )\end{matrix}$$

They appear completely as the forms of ideal transformer's equations, termed the in-phase mode of the voltage and current conversion type LC combine transformer or in-phased ideal transformer.

And from Eqs. (27) and (61) we have

$${L}_{a} = \frac{1}{{ω}^{2} ( {C}_{b 1} + {C}_{m} )} = \frac{1 - {n}_{v 1}}{{ω}^{2} {C}_{m}} = \frac{1}{{ω}^{2} {C}_{m}} [ 1 - \frac{{C}_{b}}{{k}^{2} ( {C}_{b} + {C}_{m} )} ] \qquad ( 64 )$$

Design Key Points: The in-phase mode of the voltage and current conversion type LC combine transformer (see FIG. (7)) is just the improvement or upgraded from the in-phase mode of the voltage conversion type LC combine transformer. Hence, its error analysis, design key points, and device selections all are the same as the according contents respectively of the latter stated above, with a difference that the former has functioned as the input and output current in-phased just one-step further beyond the latter.

However, the two mutual capacitors of the in-phased ideal transformer in FIG. 7 are implicated with each other during the specific designing, especially on the adjustment. In practical engineering, especially on spot test or adjustment, deviations of parameter values, influenced by lots of factors, are fated, although parameter value precision grades are ensured as high as possible in the course of designing and manufacturing; and micro-adjustments are ineluctable. Here present two methods shown in the following that can be used for on-site micro-adjustments.

Method 1: Take Lₚ as a micro-adjusted inductance with its value far below L₁, and connect Lₚ in series with the primary winding N₁ of the mutual inductor. Then Eq. (36) will become

$${n}_{v 2} = \frac{{V}_{x}}{{V}_{y}} = \frac{1}{k} [ \begin{matrix}( 1 - \frac{1}{{ω}^{2} {L}_{1} {C}_{b 2}} ) + \\ \frac{1 - {ω}^{2} {C}_{b 2} [ ( 1 - {k}^{2} ) {L}_{1} + {L}_{p} ]}{j ω {C}_{b 2} \cdot {R}_{2}}\end{matrix} ] \qquad ( 36 a )$$

Accordingly, Eq. (37) could be as ω²C_{b2}[(1−k²)L₁+Lₚ]=1 (37a) Eq. (38) as

$${n}_{v 2} = \frac{{V}_{x}}{{V}_{y}} = \frac{1}{k} ( 1 - \frac{1}{{ω}^{2} {L}_{1} {C}_{b 2}} ) = k ( 1 - \frac{{L}_{p}}{{k}^{2} {L}_{1}} ) , or \qquad ( 38 a )$$

Method II: Put a micro-adjusted inductance Lₛ (<<L₂) in series with the secondary side of the mutual inductor. Then Eq. (36) will be turned as

$$\begin{matrix}{n}_{v 2} = \frac{{V}_{x}}{{V}_{y}} = \frac{1}{k} [ \begin{matrix}( 1 - \frac{1}{{ω}^{2} {L}_{1} {C}_{b 2}} ) + \\ \frac{( 1 + {L}_{s} / {L}_{1} ) - {ω}^{2} {C}_{b 2} {L}_{1} ( 1 + {L}_{s} / {L}_{2} - {k}^{2} )}{j ω {C}_{b 2} \cdot {R}_{2} }\end{matrix} ] & ( 36 b ) \\ {ω}^{2} {L}_{1} {C}_{b 2} ( 1 - \frac{{k}^{2}}{1 + {L}_{s} / {L}_{2}} ) = {ω}^{2} {L}_{1} {C}_{b 2} ( 1 - {kn}_{v 2} ) = 1 & ( 37 b ) \\ {n}_{v 2} = \frac{{V}_{x}}{{V}_{y}} = \frac{1}{k} ( 1 - \frac{1}{{ω}^{2} {L}_{1} {C}_{b 2}} ) = \frac{k}{1 + {L}_{s} / {L}_{2}} & ( 38 b )\end{matrix}$$

Moreover, the two methods stated above are suited only when the k value of the mutual inductor is slightly greater than originally tested or L₁ a bit less than designed. To match their usages, the coil winding of L₁ should be pre-set a tap at the position of just a little bit fewer turns next to an end to make it have an inductance slightly less than originally designed. In this way, once either of the two cases above-mentioned occurs, the pre-set tap in series with the Lₚ, take Method I for an example, could be connected to where N₁ ought to so that flexible micro-adjustments could be realized. Obviously, such a way has also slightly changed the ratio of the entire transformer; when necessary, revision should be made.

### 3-2. Current Conversion-A Type LC Combined Transformer

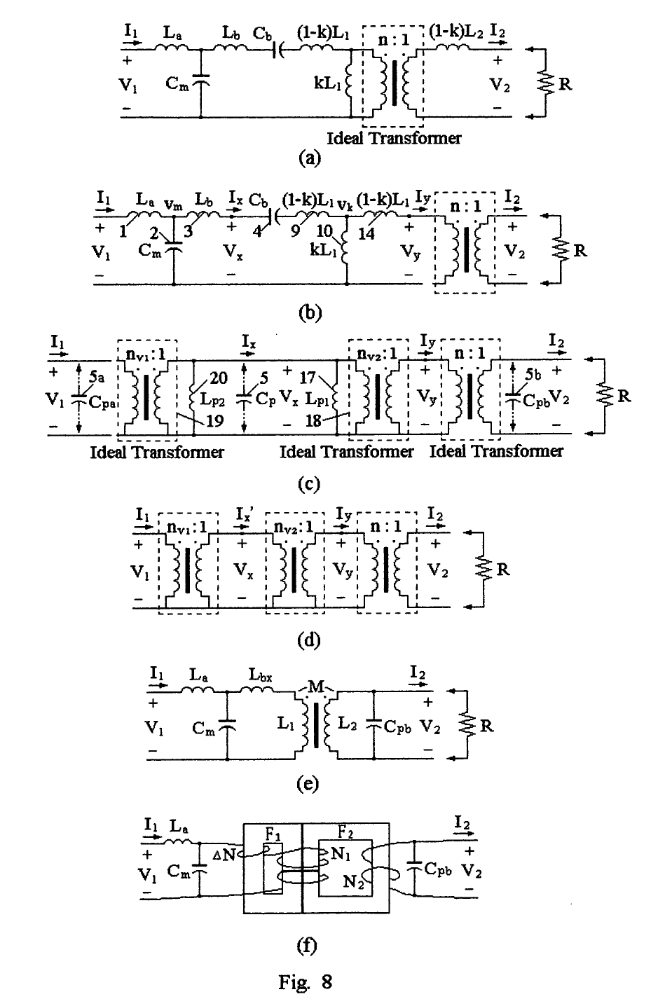

In the same way, redraw the circuit diagrams of the anti-phase mode of the voltage conversion type LC combined transformer in FIGS. 6(a) and (b) as in FIGS. 8(a) and (b). In FIG. 8(b), of the first T mutual capacitor consisting of inductances 1 and 3, capacitance 2, currents

$${I}_{x} = {n}_{v 1} {I}_{1} - \frac{{V}_{x}}{j ω ⌊ ( {L}_{a} // {L}_{b} ) / \vert {n}_{v 1} \vert ⌋} = {n}_{v 1} {I}_{1} - \frac{{V}_{2}}{j ω {L}_{p 2}} , \\ ( {L}_{p 2} = \frac{{L}_{a} // {L}_{b}}{\vert {n}_{v 1} \vert} ) \qquad ( 65 )$$

By Eqs. (47) and (65), electrically equalize the first mutual capacitor in FIG. 8(b) as an arrangement of ideal transformer 19 and its secondary in parallel with inductance 20 illustrated in FIG. 8(c). Of the second T mutual capacitor in FIG. 8(b) consisting of capacitance 4, both of the mutual inductor's leakage inductances 9 and 14, and the magnetization inductance 10, the expressions of Iₓ and Lₚ₁ are identical to Eq. (59) so that its equivalent circuit could be the same as in FIG. 7(c) of inductance 17 or Lₚ₁ in parallel with the primary of ideal transformer 18, and the circuit in FIG. 8(b) will be in circuitry equalized as in FIG. 8(c). Furthermore, if a reactive compensation capacitance 5 or Cₚ inserted in parallel connection at the position of Vₓ in FIG. 8(c), or according to practical necessity, either capacitance 5a or Cₚₐ at V₁, or capacitance 5b or C_{pb} at V₂ , with their values as

$$\begin{matrix}{C}_{p} = \frac{1}{{ω}^{2} ( {L}_{p 1} // {L}_{p 2} )} = \frac{1}{{ω}^{2}} ( \frac{1}{{k}^{2} {L}_{1}} + \frac{1 + {L}_{a} / {L}_{b}}{{L}_{b}} ) & ( 66 ) \\ {C}_{pa} = {C}_{p} / {n}_{v 1}^{2} = \frac{1}{{ω}^{2}} ( \frac{1}{{k}^{2} {L}_{1}} + \frac{1 + {L}_{a} / {L}_{b}}{{L}_{b}} ) {( \frac{{L}_{b}}{{L}_{a}} )}^{2} & ( 67 ) \\ {C}_{pb} = {k}^{2} {n}^{2} {C}_{p} = \frac{{n}^{2}}{{ω}^{2}} [ \frac{1}{{L}_{1}} + \frac{{k}^{2} ( 1 + {L}_{a} / {L}_{b} )}{{L}_{b}} ] & ( 68 )\end{matrix}$$

After compensated, functions of the circuit in FIG. 8 can be specifically and equivalently described as the form of ideal transformers illustrated in FIG. 8(d), with its voltage and current relations as

$$\{ \begin{matrix}\frac{{V}_{1}}{{V}_{2}} = \frac{{V}_{1}}{{V}_{x}} \cdot \frac{{V}_{x}}{{V}_{y}} \cdot \frac{{V}_{y}}{{V}_{2}} = {n}_{v 1} \cdot {n}_{v 2} \cdot n = {n}_{v} = - \frac{{nkL}_{a}}{{L}_{b}} & ( 69 ) \\ \frac{{I}_{1}}{{I}_{2}} = \frac{{I}_{1}}{{I}_{x}^{\cdot }} \cdot \frac{{I}_{x}^{\cdot }}{{I}_{y}} \cdot \frac{{I}_{y}}{{I}_{2}} = \frac{1}{{n}_{v 1}} \cdot \frac{1}{{n}_{v 2}} \cdot \frac{1}{n} = \frac{1}{{n}_{v}} = - \frac{{L}_{b}}{{nkL}_{a}} & ( 70 )\end{matrix}$$

These equations show the relations of anti-phased voltages and currents, termed the anti-phase mode of the voltage and current conversion type LC combined transformer or anti-phased ideal transformer. As well, here present the circuit arrangements of the ideal transformers upgraded from FIGS. 6(f) and (g) respectively as in FIGS. 8(e) and (f).

Design Key Points: In the same way as in the in-phase mode, the anti-phase mode of the voltage and current conversion type LC combine transformer (see FIG. (8)) is also just the improvement or upgraded from the anti-phase mode of the voltage conversion type LC combine transformer. Hence, its error analysis, design key points, and device selections all are the same as the according contents respectively of the latter stated above, with a difference that the former has functioned as the input and output current anti-phased just one-step further beyond the latter.

### 3-3. Voltage and Current Conversion-A Type LC Combined Transformer

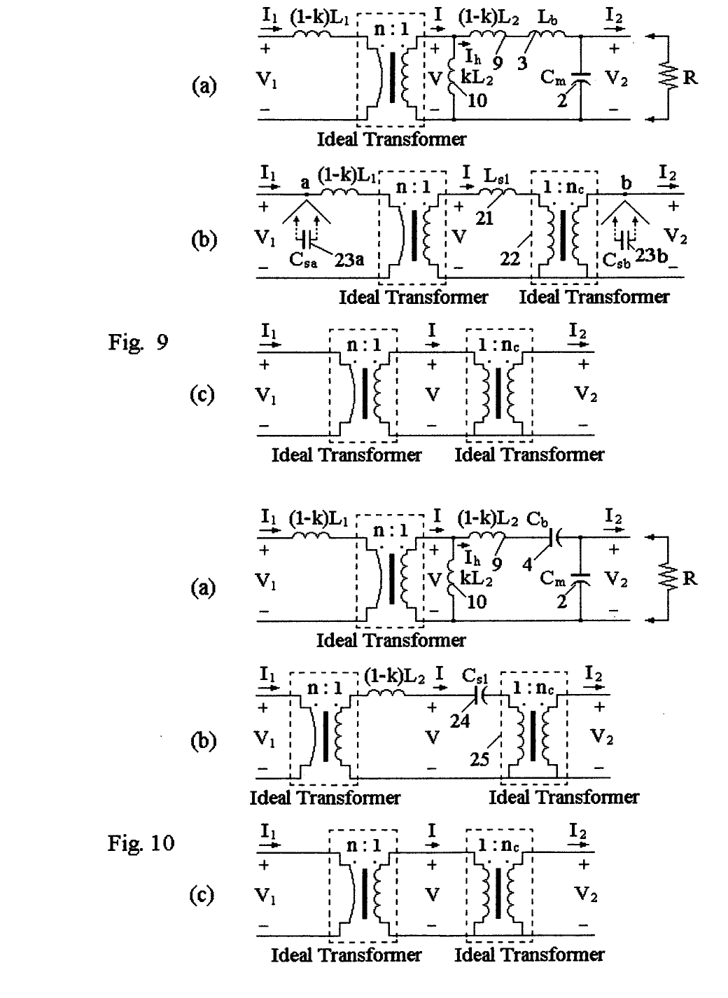

Firstly review the current conversion-A type of the LC combined transformer and redraw the circuit diagram in FIG. 3(a) as in FIG. 9(a). In FIG. 9(a), of the Δ or π mutual capacitor consisting of inductances 3, 9, 10, and capacitance 2, voltage

$$\begin{matrix}V = j ω ( I - {I}_{h} ) {kL}_{2} = j ω ( I - {I}_{2} ) {kL}_{2} - j ω ( {I}_{h} - {I}_{2} ) {kL}_{2} \\ = j ω ( {I}_{1} - \frac{{I}_{1}}{{n}_{c}} ) {kL}_{2} - j ω ( j ω {CV}_{2} ) {kL}_{2} \\ = j ω ( 1 - \frac{1}{{n}_{c}} ) {kL}_{2} {I}_{1} + {ω}^{2} {kL}_{2} {CV}_{2} \\ = j ω {L}_{s 1} {I}_{1} + \frac{1}{{n}_{c}} {V}_{2} ; [ {L}_{s 1} = ( 1 - \frac{1}{{n}_{c}} ) {kL}_{2} ]\end{matrix} \qquad ( 71 )$$

From Eqs. (10) and (71), obtain the equivalent circuit, between V and V₂ in FIG. 9(b), of ideal transformer 22 and in series with its primary winding the equivalent input inductance 21 or Lₛ₁ of the mutual capacitor. Next, let's insert a compensation capacitance 23a or Cₛₐ in series connection at point a of input port, or when necessary, insert a compensation capacitance 23b or C_{sb} in series connection at point b of output port, with their values separately as

$$\begin{matrix}{C}_{sa} = \frac{1}{{ω}^{2} [ ( 1 - k ) {L}_{1} + {n}^{2} {L}_{s 1} ]} = \frac{1}{{ω}^{2} {L}_{1} ( 1 - k / {n}_{c} )} & ( 72 ) \\ {C}_{sb} = \frac{1}{{ω}^{2} {n}_{c}^{2} [ ( 1 - k ) {L}_{2} + {L}_{s 1} ]} = \frac{1}{{ω}^{2} {n}_{c} {L}_{2} ( {n}_{c} - k )} & ( 73 )\end{matrix}$$

Functions of the circuit in FIG. 9(b) after compensation can be equivalently expressed as the form of ideal transformers in cascaded connection, with the voltage and current relations as

$$\{ \begin{matrix}\frac{{V}_{1}}{{V}_{2}} = \frac{{V}_{1}}{V} \cdot \frac{V}{{V}_{2}} = n \cdot \frac{1}{{n}_{c}} = \frac{{nkL}_{2}}{{L}_{b} + {L}_{2}} & ( 74 ) \\ \frac{{I}_{1}}{{I}_{2}} = \frac{{I}_{1}}{I} \cdot \frac{I}{{I}_{2}} = \frac{1}{n} \cdot {n}_{c} = \frac{{L}_{b} + {L}_{2}}{{nkL}_{2}} & ( 75 )\end{matrix}$$

They completely appear as the forms of an ideal transformer's equations, referred to as the voltage and current conversion-A type of the LC combined transformer, or conversion-A ideal transformer or ideal transformer A, when the circuit in FIG. 9 satisfying the condition either of Eqs. (72) and (73).

Design Key Point: The voltage and current conversion-A type LC combined transformer (FIG. (9)) is just the improvement or upgraded from the current conversion-A type of the LC combined transformer. Hence, its error analysis, design key points, and device selections all are the same as the according contents respectively of the latter stated above, with a difference that the former has functioned as the input and output voltage in-phased just one-step further beyond the latter.

### 3-4. Current Conversion-A Type LC Combined Transformer

In the same way, redraw the circuit diagram of the current conversion-B type LC combined transformer in FIG. 4(a) as in FIG. 10(a). In FIG. 10(a), of the Δ or π mutual capacitor consisting of inductances 9 and 10, and capacitances 2 and 4, voltage

$$\begin{matrix}\begin{matrix}V = j ω ( I - {I}_{h} ) {kL}_{2} = j ω ( I - {I}_{2} ) {kL}_{2} - j ω ( {I}_{h} - {I}_{2} ) {kL}_{2} \\ = j ω ( I - \frac{I}{{n}_{c}} ) {kL}_{2} - j ω ( j ω {C}_{m} {V}_{2} ) {kL}_{2} \\ = j ω ( 1 - \frac{1}{{n}_{c}} ) {kL}_{2} I + {ω}^{2} {kL}_{2} {C}_{m} {V}_{2} \\ = j ω {L}_{s 1} I + \frac{1}{{n}_{c}} {V}_{2} ; [ {L}_{s 1} = ( 1 - \frac{1}{{n}_{c}} ) {kL}_{2} , when {n}_{c} \geq 1 ]\end{matrix} & ( 76 ) \\ \begin{matrix} = j ( 1 - \frac{1}{{n}_{c}} ) \cdot \frac{1}{ω {n}_{c} {C}_{m}} \cdot I + \frac{1}{{n}_{c}} {V}_{2} \\ = \frac{1}{j ω {C}_{s 1}} I + \frac{1}{{n}_{c}} {V}_{2} ; ( {C}_{s 1} = \frac{{n}_{c}^{2} {C}_{m}}{1 - {n}_{c}} , when {n}_{c} < 1 )\end{matrix} & ( 77 )\end{matrix}$$

In most cases, there exists n_{c}<1; thus the equation above should be expressed as taking on the series equivalent capacitance Cₛ₁ as in Eq. (77) so that in FIG. 10, the Δ mutual capacitor between V and V₂ can be replaced by an equivalent circuit of ideal transformer 25 and in series with its primary the equivalent input capacitance 24 or Cₛ₁, with the mutual inductor's primary leakage inductance (1−k)L₁ in FIG. 10(a) being equalized as its secondary leakage inductance (1−k)L₂ in FIG. 10(b). Next, assume

$$j ω ( 1 - k ) {L}_{2} + \frac{1}{j ω {C}_{s 1}} = 0 , \\ i . e . {ω}^{2} ( 1 - k ) {L}_{2} {C}_{s 1} = {ω}^{2} ( 1 - k ) {L}_{2} \frac{{n}_{c}^{2} {C}_{m}}{1 - {n}_{c}} = 1 , \\ or {ω}^{2} ( 1 - k ) {L}_{2} {n}_{c}^{2} {C}_{m} = 1 - {n}_{c} ;$$

and notice Eq. (20), namely

$${ω}^{2} {L}_{2} {C}_{m} = \frac{1}{{kn}_{c}} ,$$

being substituted in as

$$\frac{1 - k}{k} \cdot {n}_{c} = 1 - {n}_{c} ,$$

or say when n_{c}=k, or

$$\frac{{C}_{m}}{{C}_{b}} = \frac{1}{{k}^{2}} - 1 \qquad ( 78 )$$

FIG. 10(b) could be equivalently replaced as FIG. 10(c), with the network port voltage and current equations as

$$\{ \begin{matrix}\frac{{V}_{1}}{{V}_{2}} = \frac{{V}_{1}}{V} \cdot \frac{V}{{V}_{2}} = n \cdot \frac{1}{{n}_{c}} = nk ( 1 + \frac{{C}_{m}}{{C}_{b}} ) & ( 79 ) \\ \frac{{I}_{1}}{{I}_{2}} = \frac{{I}_{1}}{I} \cdot \frac{I}{{I}_{2}} = \frac{1}{n} \cdot {n}_{c} = \frac{{C}_{b}}{nk ( {C}_{b} + {C}_{m} )} & ( 80 )\end{matrix}$$

These are also equations of an ideal transformer, which is why the circuit in FIG. 10, when satisfying condition Eq. (78), is referred to as the voltage and current conversion-B type of the LC combined transformer, or conversion-B ideal transformer or ideal transformer B.

Design Key Point: The voltage and current conversion-B type LC combined transformer (FIG. (10)) is also just the improvement or upgraded from the current conversion-B type of the LC combined transformer. Hence, its error analysis, design key points, and device selections all are the same as the according contents respectively of the latter stated above, with a difference that the former has functioned as the input and output voltage in-phased just one-step further beyond the latter.

4. Function of Waveform Conversion from Square-Wave to Quasi-Sinusoid

All the three categories or types of the LC combined transformers presented by this invention possess the function of waveform conversion or waveform isolation from square-wave to quasi-sinusoid [Note: take fundamental filter of square-wave as a typical example of waveform conversion, and rectifier transformer as a typical application of waveform isolation]. The following come analysis and explains of only one example for its operating principle and effect [Note: see Appendix III “Functions of Waveform Conversion from Square-Wave to Quasi-Sinusoid of the Mutual Capacitor (Continue)”].

Let's investigate the working status of the in-phase mode voltage conversion type LC combined transformer in FIG. 5 applied with a supply of cycling or periodic square-wave sequence.

Assuming that v₁(t) is a voltage of symmetrical cycling square-wave implemented on the input port of the mutual capacitor, with a cyclic frequency ω=2πf=2π/T and its Fourier's series as

v₁(t)=V₁₁ sin ωt+V₁₃ sin 3ωt+V₁₅ sin 5ωt+ . . . +V₁ₘ sin kωt+ . . . , (m=1,3,5, . . . ) (81)

where, V₁₁, V₁₃, V₁₅ . . . mean the magnitudes of the fundamental, third harmonic, fifth harmonic . . . etc. In addition, the magnitude ratio of m-th harmonic to fundamental for a symmetrical cycling square-wave is V₁ₘ/V₁₁=1/m.

From Eqs. (26) to (28), magnitude of the m-th harmonic of the output voltage Vₓ of the first mutual capacitor in FIG. 5 under the implement of v₁(t) will be worked out as

$$\begin{matrix}\vert {V}_{xm} \vert = \frac{\vert {V}_{1 m} \vert}{\sqrt{\begin{matrix}{[ 1 - {m}^{2} ( 1 - {n}_{v 1} ) ]}^{2} + \\ {[ \frac{1}{ω {C}_{m} {R}_{1}} ( \frac{1}{{n}_{v 1}} - 1 ) ( \frac{1}{m} - m ) ]}^{2}\end{matrix}}} \\ or expressed as \\ \vert \frac{{V}_{xm}}{{V}_{x 1}} \vert = \vert \frac{{V}_{1 m}}{{V}_{11}} \vert \cdot \frac{{n}_{v 1}}{\sqrt{\begin{matrix}{[ 1 - {m}^{2} ( 1 - {n}_{v 1} ) ]}^{2} + \\ {[ \frac{1}{ω {C}_{m} {R}_{1}} ( \frac{1}{{n}_{v 1}} - 1 ) ( \frac{1}{m} - m ) ]}^{2}\end{matrix}}} & ( 82 ) \\ = \frac{1}{m} \cdot \frac{{n}_{v 1}}{\sqrt{{[ 1 - {m}^{2} ( 1 - {n}_{v 1} ) ]}^{2} + {[ \frac{1}{ω {C}_{m} {R}_{1}} ( \frac{1}{{n}_{v 1}} - 1 ) ( \frac{1}{m} - m ) ]}^{2}}} & ( 83 )\end{matrix}$$

By this equation, calculate when nᵥ₁=0.75, 0.5, 0.25, ωCₘR₁=0.1, 1, 2,10, 100, the values of

$$\vert \frac{{V}_{xm}}{{V}_{x 1}} \vert$$

for the mutual capacitor as recorded in the following form:

| | | \|Vₓₘ/Vₓ₁\|, when m = | | | | | |
|---|---|---|---|---|---|---|---|
| nᵥ₁ | ωCₘR₁ | 1 | 3 | 5 | 7 | 9 | 11 |
| 0.75 | 0.1 | 1.0000 | .0278 | .0089 | .0042 | .0024 | .0015 |
| | 1 | 1.0000 | .1630 | .0273 | .0093 | .0043 | .0023 |
| | 2 | 1.0000 | .1884 | .0282 | .0095 | .0043 | .0023 |
| | 10 | 1.0000 | .1995 | .0286 | .0095 | .0043 | .0023 |
| | 100 | 1.0000 | .2000 | .0286 | .0095 | .0043 | .0023 |
| 0.50 | 0.1 | 1.0000 | .0062 | .0020 | .0010 | .0006 | .0004 |
| | 1 | 1.0000 | .0379 | .0080 | .0029 | .0014 | .0008 |
| | 2 | 1.0000 | .0445 | .0085 | .0030 | .0014 | .0008 |
| | 10 | 1.0000 | .0475 | .0087 | .0030 | .0014 | .0008 |
| | 100 | 1.0000 | .0476 | .0087 | .0030 | .0014 | .0008 |
| 0.25 | 0.1 | 1.0000 | .0010 | .0003 | .0002 | .0001 | .0001 |
| | 1 | 1.0000 | .0085 | .0022 | .0009 | .0004 | .0002 |
| | 2 | 1.0000 | .0119 | .0026 | .0010 | .0005 | .0002 |
| | 10 | 1.0000 | .0144 | .0028 | .0010 | .0005 | .0003 |
| | 100 | 1.0000 | .0145 | .0028 | .0010 | .0005 | .0003 |

Form 1 List for calculations of |Vₓₘ/Vₓ₁| by Eq. (83) when nᵥ₁ and ωCₘR₁ have different values

Design Considerations: From the results of the listed data, the influence on the output voltage by the harmonics of fifth and over is almost negligible; the influence of the third harmonic increasing accompanied with increase of nᵥ₁ (generally, negligible when nᵥ₁<0.5); the change of (ωCₘR₁) shows the load carrying capacity of the mutual capacitor not bad, with the load heavier the better fundamental filtering characteristic of the mutual capacitor. However, the heavier load for the mutual capacitor, the worse errors for it will occur determined by Eqs. (29) through (32). Therefore, during designing in practice, balances need to be made on or between the filtering characteristic, the load carrying capacity, and the ratio errors.

### 5. Utilization of Push-Pull on Inductor

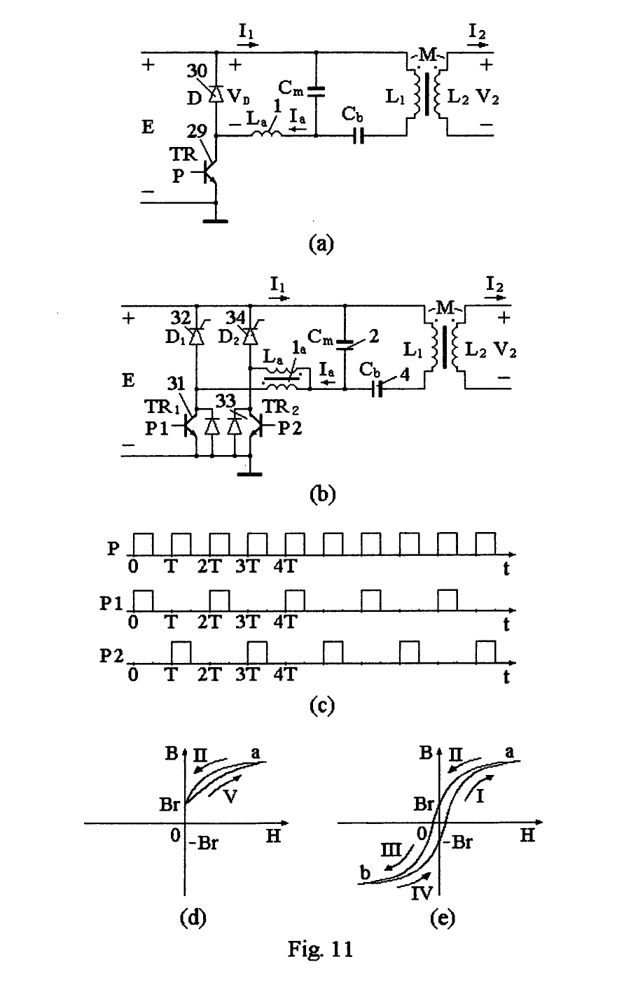

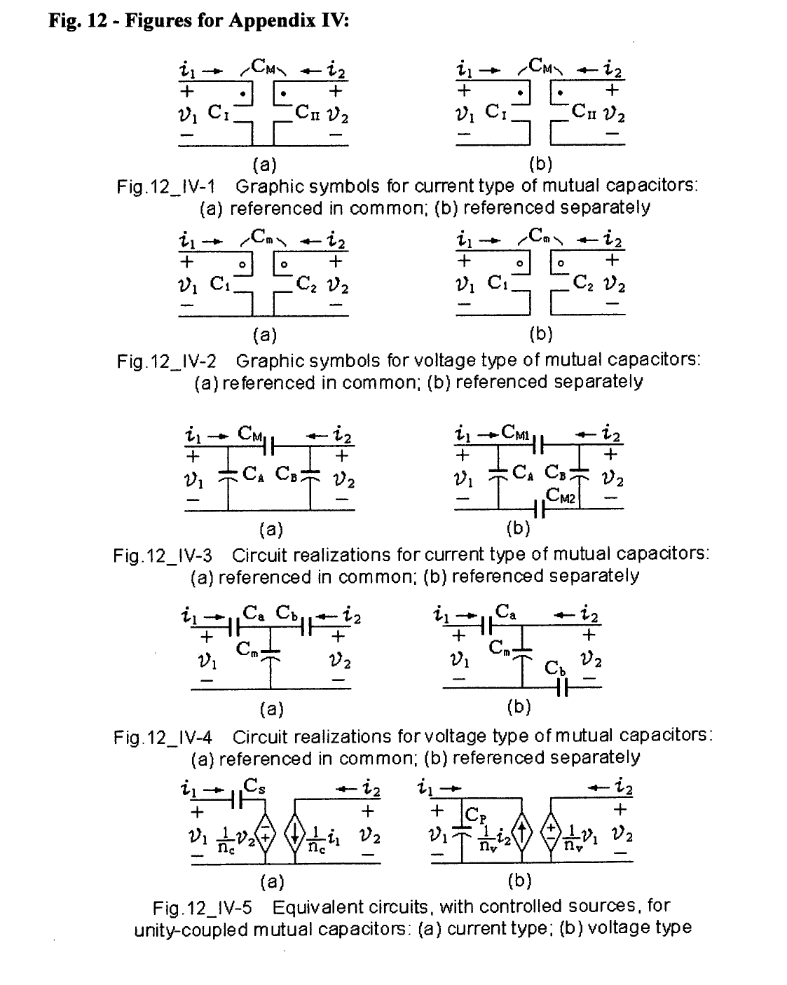

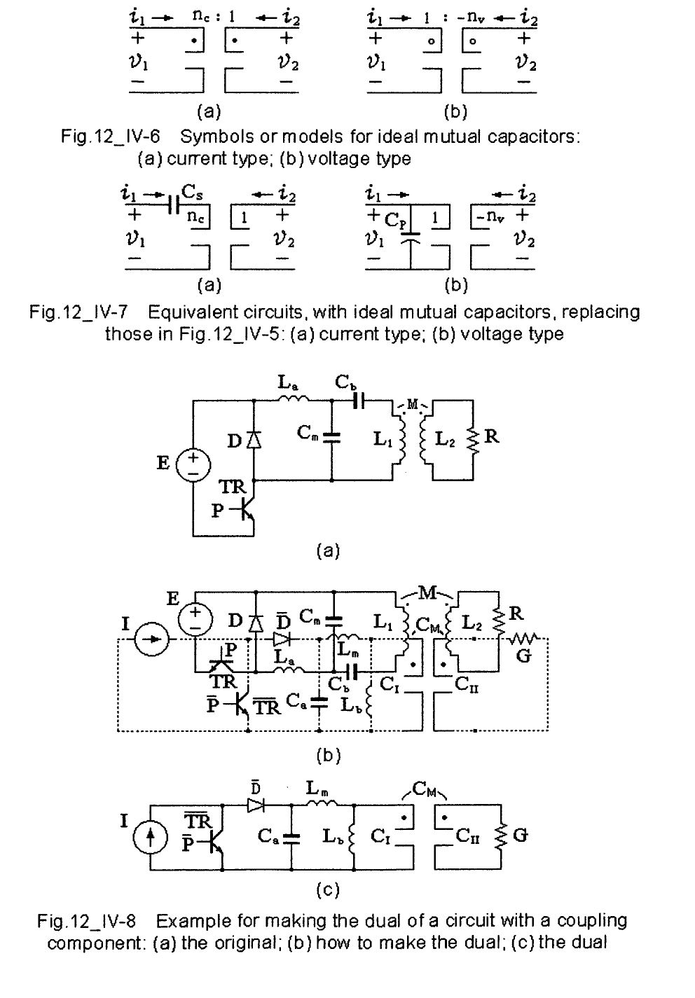

The utilization of push-pull on inductor is also termed usage of the push-pull inductor. FIG. 11(a) is a principle scheme and also a trial circuit of the waveform conversion from square-wave to quasi-sinusoid using the circuit either in FIG. 5 or in FIG. 7. FIG. 11(b) is an improvement from FIG. 11(a) by employing the push-pull inductor.

In FIG. 11(a), when the control-in terminal P of switch 29 or TR is input the signal with a waveform like P as in FIG. 11(c), the waveform of input voltage V_{D} of the LC combined transformer is also a single-polar pulsed square-wave sequence in similar with P, while the input current I₁ or Iₐ is a single-polar periodic waveform as well, by which the cores of inductor 1 or Lₐ is magnetized with a locus curve or hysteresis loop as shown in FIG. 11(d). Within a cycle in steady-state operation of the circuit in FIG. 11(a), commencing at point Br in FIG. 11(d) with switch 29 or TR closed and switch 30 or D open while Iₐ increasing, the magnetic flux density, accompanied with the change of the magnetic field strength, moves up the curve V to point a; and then switch 29 or TR open and switch 30 closed as well as Iₐ decreasing, the flux density moves down the curve II back to point Br. This illustrates that the core's magnetization phenomenon occurs only in the first quadrant, which means that the core is not effectively utilized yet.

To overcome this drawback and make full use of the cores, it will result in a good effect by using a full-bridge or half-bridge circuit to drive the LC combined transformer. However, a bridge circuit has a shortage that it needs a complicated switch-control-and-driving circuit, for the reason that the reference voltages of its two sets of alternately working switches are not at a same potential.

To achieve this same goal, usage of the push-pull inductor is another choice (see FIG. 11(b)), which includes: \textcircled{1} one center-tapped inductor 1a or Lₐ; two sets of electrically-symmetric driving switches such as transistors 31 and 33 [Note 1: Examples for “electrically-symmetric” are as those of driving switches, passive switches and their driving signals etc in double-ended circuits such as half-bridge, full-bridge and push-pull converters. Note 2: Suppose that the circuit herein belongs to positive logic and employs npn bipolar junction transistors (BJTs) though this application is not limited on positive logic nor to bipolar transistors employed only]; two sets of electrically-symmetric passive switches such as diodes 32 and 34; with the value and current rating of inductance Lₐ, and electrical specifications of the switches all determined by the requirements of design. \textcircled{2} one end of inductor 1a electrically connected to the collector of transistor 31 and also to the anode of diode 32, the other end of 1a to the collector of transistor 33 and also to the anode of diode 34, the emitters of transistors 31 and 33 electrically connected together to the reference level, the cathodes of diodes 32 and 34 electrically connected together to high level of the source, the center-tap of inductor la to an appropriate level [Note: In this example, to the junction between capacitances 2 and 4], the bases or control-in terminals of transistors 31 and 33 separately connected to corresponding control-and-driving signals with two periods as a cycle, electrically-symmetrical to each other and alternately working. \textcircled{3} the push-pull inductor employing a technique of the bi-periodically time-shared driving as described as: the PWM control-and-drive signals for switches 31 and 33 in FIG. 11(b) separately be chosen as those like P1 and P2 as shown in FIG. 11(c); although the total current, Iₐ in FIG. 11(b), of the push-pull inductor remains the same as in FIG. 11(a), the magnetization mode of the cores of inductor 1a or Lₐ is changed (see FIG. 11(e)) as: during the steady-state operation of the circuit in FIG. 11(b), when only switch 31 or TR₁ turned on, the core's magnetization locus goes up curve I from point −Br to point a; then switch 31 or TR₁ turned off and diode 32 or D₁ turned on, while magnetizing down curve II from point a back to point Br till no later than the moment that the first period of the circuit operation ends; symmetrically, the second period starts when only switch 33 or TR₂ turned on, the cores' magnetizing continuously moving down curve III from point Br to point b; thereafter, switch 33 or TR₂ turned off and diode 34 or D₂ turned on, while the locus going up curve IV from point b back to point −Br till no later than the end of the second period of the circuit operation and also of one cycle of the bi-periodically time-shared driving [Note: Herein the working sequence of switches is described by investigating the cores' magnetization loci; it also can be described simply by stating the switch operations as: switch 33 being off for the first period while switch 31 on not longer than T/2 before turning off; for the second period switch 31 being off while switch 33 on not longer than T/2 before turning off, with the end of second period as the end of a cycle of the bi-periodically time-shared driving; where T is the time of switch operating period of the circuit].

In this example, the inductance value of inductor 1a in FIG. 11(b) is equal to that of inductor 1 in FIG. 11(a). In most cases, inductor 1a may use same cores and share the same coil turns number as those for inductor 1, with the differences that, two coils of N turns, if N is the coil turns number for inductor 1, wound bifilarly in parallel or separately in sections; and the wire cross-sectional area of the 1a coils equal to half that of 1's; and the wound twin coils connected series-aiding, with the connected point as the center-tap.

The technique of bi-periodically time-shared driving, in the utilization of push-pull on inductor, extends the cores' magnetization as widely as to all four quadrants, or full range of its magnetization characteristic, greatly upgrading its effectiveness, and with its size relatively decreased as well as the loss and cost accordingly declined. In addition, it eliminates problem of the cores' unsymmetrical magnetization phenomenon in conventional push-pull driving mode and greatly alleviates the cross-conductance of driving switches. Therefore, this technique is also suited for driving any other double-ended circuits, including bridge, half-bridge, and conventional push-pull, etc. As well, the usage of push-pull inductor, besides for the mutual capacitor or the LC combined transformer, could be exploited in other circuits, such as in active power factor correction (APFC) circuit, and the like.

### Postscript

Although this description, Appendixes included, contains numerous details and specificities, it is to be understood that these are merely illustrative of the present invention, and are not to be constructed as limitations. Many modifications will be readily apparent to those skilled in the art, which do not depart from the spirit and the scope of the invention, as defined by the appended claims and their legal equivalents.

The embodiments of the invention in which an exclusive property or: privilege is claimed are defined as follows:

1. A species of electrical transformer, termed LC combined transformer, for transferring electric signal or/and energy of periodical sinusoid or periodic wave at least, and linearly altering the magnitudes of voltage or/and current, which is characterized as:
consisting of some linear capacitances, linear inductances and an linear mutual inductor (i.e. the conventional transformer);
said mutual inductor's leakage inductances and magnetization inductance combined with said capacitances and/or said inductances so as to constitute at least one unity-coupled mutual capacitors;
said mutual capacitor being a two-port electrical network of a Δ or T or their variant and equivalent configuration of at least three in total said capacitances and/or said inductances;
when neglecting power loss, said unity-coupled Δ (or π) mutual capacitor exhibiting a characteristic of pure current conversion between ports, and/or said unity-coupled T (or Y) mutual capacitor exhibiting a characteristic of pure voltage conversion between ports;
and, between said at least one unity-coupled mutual capacitors and between some of them and the ideal transformer peeled off said leakage inductances and magnetization inductance from said mutual inductor there existing relations of electrical connection in cascade one after another.

2. The LC combined transformer defined in claim 1, whereof the design scheme of a practical and generalized circuit configuration (FIG. 2), which is described as:
comprising one or two said unity-coupled mutual capacitors cascade-connected to said ideal transformer of said mutual inductor, consisting of two said linear inductances, three said linear capacitances and one said linear mutual inductor, with its electrical connections stated as follows;
one end of the first said inductance designated as input terminal, the other end connected with one end of the first said capacitance and also one end of the second said inductance, the other end of the second inductance connected with one end of the second said capacitance and also one end of the third said capacitance, the other end of second capacitance connected to one terminal of the primary winding of said mutual inductor, the other end of first capacitance and the other end of third capacitance together connected with the other terminal of said primary winding as well as designated as common terminal, defining said input terminal and said common terminal as input port of the LC combined transformer, defining the two terminals of the secondary winding of said mutual inductor as its output port;
with that the position of third capacitance could be moved to and connected in parallel with said input port or output port when necessary, that the positions of second inductance and second capacitance could be switched to each other when the third capacitance not connected to the junction between second inductance and second capacitance, that the designation or definition of said input port and said output port could be interchanged according to necessity, and that the sequence or orders between said cascade-connections of two said unity-coupled mutual capacitors and said ideal transformer could be altered as long as the altered version is electrically equivalent to the circuit presented herein.

3. The LC combined transformer defined in claim 2, whereof said linear inductances, capacitances and mutual inductor all being real components with power loss (FIG. 2(c)) although their magnitude values could be separately produced by the principle of series-parallel equivalence, with their values ranged and characterized as:
said first and second inductances respectively being definitely-valued or zero-valued (short-circuited), said first capacitance definitely-valued, said second capacitance definitely-valued or indefinitely-valued (short-circuited), said third capacitance definitely-valued or zero-valued (open-circuited), the self-inductances of both primary and secondary windings of said mutual inductor definitely-valued respectively;
said linearity of real components meaning proximately linear of satisfying the requirements of conversion precision of said transformer;
and, that said mutual inductor might be multi-winding on condition that it can be electrically equalized as a double-winding and employed within this invention.

4. The LC combined transformer defined in claim 3, whereof the first embodiment referred to as current conversion-A type LC combined transformer, or in short as conversion-A ideal current transformer or ideal current transformer A (FIG. 3), is described as:
consisting of said mutual inductor of two windings with self-inductances definitely-valued respectively, said first capacitance definitely-valued, said second inductance definitely-valued, said first inductance and second capacitance short-circuited, and said third capacitance open-circuited;
with designations of the winding connected with said inductance and capacitance as the secondary of said mutual inductor, of the other winding as its primary and also as input port of this embodiment, and of the two terminals of said first capacitance as the output port.

5. The current conversion-A type LC combined transformer defined in claim 4, wherein two current conversions performed by the cascade-connected said ideal transformer of said mutual inductor and one unity-coupled Δ (or π) mutual capacitor, is characterized as:
said mutual capacitor exhibiting a characteristic of pure current conversion between ports when neglecting power loss and designed as according with the condition ω²Cₘ(L₂+L_{b})=1 (Eq. 9), with a result of this transformer's port current ratio as
$$\frac{{I}_{1}}{{I}_{2}} = \frac{{n}_{c}}{n} = \frac{1}{nk} ( 1 + \frac{{L}_{b}}{{L}_{2}} ) , \qquad ( Eq . 11 )$$
where Cₘ is the value of said first capacitance, L₂ the self-inductance value of said secondary winding of said mutual inductor, L_{b} the value of said second inductance, and ω the electrical angular frequency/velocity of said periodic wave applied to this transformer, I₁ the rms value of sinusoidal current entering said input port, I₂ the rms value of sinusoidal current leaving said output port, k the coupling coefficient of said mutual inductor, n the ratio of said mutual inductor equal to its turns ratio of said primary winding to said secondary winding, and n_{c} the current ratio of input port to output port of said unity-coupled Λ (or π) mutual capacitor.

6. Performance of the integration design approach of an inductor and a mutual inductor, developed from the current conversion-A type LC combined transformer defined in claim 4, turning out a multi-purpose integrated inductor and mutual inductor (FIGS. 3(c) and (d)) which is characterized as:
comprising the core magnetic circuit of said mutual inductor, the core magnetic circuit of said inductor, the primary winding of said mutual inductor, the two-in-one common coil served both as the secondary winding of said mutual inductor and also as the winding of said inductor, and the auxiliary winding (set when needed) of said inductor;
said primary winding of said mutual inductor being wound around just said core magnetic circuit of said mutual inductor with its two terminals treated as input port, said common coil wound around the paralleled and adjacent-to-each-other portions of both said core magnetic circuit of said mutual inductor and that of said inductor, said auxiliary winding wound around just said core magnetic circuit of said inductor, and said common coil and said auxiliary winding connected series-aiding with the terminals after series as output port;
the cores of said mutual inductor and said inductor being possibly made from any available magnetic material, shaped as any realizable appearances and styles, cross-sectional areas probably unequal to each other, and magnetic circuit lengths maybe different from each other;
designations of said input port and said output port being interchangeable when needed;
and, the turns ratio, the coupling coefficient, the primary self-inductance, the secondary self-inductance, and relations of currents and powers all being determined as for those of conventional mutual inductors, while the total output inductance being almost the sum of said secondary self-inductance of said mutual inductor and the inductance determined by all together of said common coil, said auxiliary winding and said magnetic circuit of said inductor provided with said magnetic circuits in a qualified linearity.

7. The LC combined transformer defined in claim 3, whereof the second embodiment referred to as current conversion-B type LC combined transformer, or in short as conversion-B ideal current transformer or ideal current transformer B (FIG. 4), is described as:
consisting of said mutual inductor of two windings with self-inductances definitely-valued respectively, said first and second capacitances both definitely-valued, said first and second inductances both short-circuited, and said third capacitance open-circuited;
with designations of the winding connected with said capacitances as the secondary of said mutual inductor, of the other winding as its primary and also as input port of this embodiment, and of the two terminals of said first capacitance as the output port.

8. The current conversion-B type LC combined transformer defined in claim 7, wherein two current conversions performed by the cascade-connected said ideal transformer of said mutual inductor and one unity-coupled Δ (or π) mutual capacitor, is characterized as:
said mutual capacitor exhibiting a characteristic of pure current conversion between ports when neglecting power loss and designed as according with the condition
$${ω}^{2} {L}_{2} ( \frac{{C}_{b} {C}_{m}}{{C}_{b} + {C}_{m}} ) = 1$$
(Eq. 19), with a result of this transformer's port current ratio as
$$\frac{{I}_{1}}{{I}_{2}} = \frac{{n}_{c}}{n} = \frac{{C}_{b}}{nk ( {C}_{b} + {C}_{m} )} , \qquad ( Eq . 21 )$$
where Cₘ is the value of said first capacitance, C_{b} the value of said second capacitance, L₂ the self-inductance value of said secondary winding of said mutual inductor, and ω the electrical angular frequency/velocity of said periodic wave applied to this transformer, I₁ the rms value of sinusoidal current entering said input port, I₂ the rms value of sinusoidal current leaving said output port, k the coupling coefficient of said mutual inductor, n the ratio of said mutual inductor equal to its turns ratio of said primary winding to said secondary winding, and n_{c} the current ratio of input port to output port of said unity-coupled Δ (or π) mutual capacitor.

9. The LC combined transformer defined in claim 3, whereof the third embodiment referred to as in-phase mode voltage conversion type LC combined transformer, or in short as in-phased ideal voltage transformer (FIG. 5), is described as:
consisting of said mutual inductor of said primary and secondary windings with self-inductances definitely-valued respectively, said first inductance definitely-valued, said first and second capacitances both definitely-valued, said second inductance short-circuited, and said third capacitance open-circuited.

10. The in-phase mode voltage conversion type LC combined transformer defined in claim 9, wherein three voltage conversions performed by the cascade-connected said ideal transformer of said mutual inductor and two unity-coupled T (or Y) mutual capacitors, is characterized as:
said two unity-coupled mutual capacitors each exhibiting a characteristic of pure voltage conversion between ports when neglecting power loss and designed as according with the conditions ω²Lₐ(C_{b1}+Cₘ)=1 (Eq. 27) and ω²(1−k²)L₁C_{b2}=1 (Eq. 37), with a result of this transformer's port voltage ratio as
$$\frac{{V}_{1}}{{V}_{2}} = \frac{{knC}_{b 1}}{{C}_{b 1} + {C}_{m}} , \qquad ( Eq . 44 )$$
where Lₐ is the value of said first inductance, L₁ the self-inductance value of said primary winding of said mutual inductor, Cₘ the value of said first capacitance, C_{b1} and C_{b2} respectively the values of the first and the second of two series components of said second capacitance C_{b} or
$${C}_{b} = {C}_{b 1} ⊥ {C}_{b 1} = \frac{{C}_{b 1} {C}_{b 2}}{{C}_{b 1} + {C}_{b 2}} ,$$
ω the electrical angular frequency/velocity of said periodic wave applied to this transformer, V₁ and V₂ the rms values of sinusoidal voltages across said input port and said output port respectively, k the coupling coefficient of said mutual inductor, and n the ratio of said mutual inductor equal to its turns ratio of said primary winding to said secondary winding.

11. The LC combined transformer defined in claim 3, whereof the fourth embodiment referred to as anti-phase mode voltage conversion type LC combined transformer, or in short as anti-phased ideal voltage transformer (FIG. 6), is described as:
consisting of said mutual inductor of said primary and secondary windings with self-inductances definitely-valued respectively, said first inductance definitely-valued, said second inductance definitely-valued or short-circuited in case, said first capacitance definitely-valued, said second capacitance definitely-valued or short-circuited in case, and said third capacitance open-circuited or definitely-valued when needed.

12. The anti-phase mode voltage conversion type LC combined transformer defined in claim 11, wherein three voltage conversions performed by the cascade-connected said ideal transformer of said mutual inductor and two unity-coupled T (or Y) mutual capacitors, is characterized as:
said two unity-coupled mutual capacitors each exhibiting a characteristic of pure voltage conversion between ports when neglecting power loss and designed as according with the conditions ω²Cₘ(Lₐ//L_{b})=1 (Eq. 46) and ω²(1−k²)L₁C_{b}=1 (Eq. 37), with a result of this transformer's port voltage ratio as
$$\frac{{V}_{1}}{{V}_{2}} = - kn \frac{{L}_{a}}{{L}_{b}} , \qquad ( Eq . 53 )$$
where Lₐ is the value of said first inductance, L_{b} the value of said second inductance, L₁ the self-inductance value of said primary winding of said mutual inductor, Cₘ the value of said first capacitance, C_{b} the value of said second capacitance, ω the electrical angular frequency/velocity of said periodic wave applied to this transformer, V₁ and V₂ the rms values of sinusoidal voltages across said input port and said output port respectively, k the coupling coefficient of said mutual inductor, and n the ratio of said mutual inductor equal to its turns ratio of said primary winding to said secondary winding.

13. Usage of the push-pull inductor (illustrated in FIG. 11(b)), developed for the in-phase mode voltage conversion type LC combined transformer defined in claim 9, which includes:
\textcircled{1} one center-tapped inductor 1a, two electrically-symmetric driving switches such as transistors depicted as 31 and 33 [Note: neither positive logic nor bipolar junction transistors (BJTs) is the only choice for this application though both are employed in the circuit of the example herein], and two electrically-symmetric passive switches such as diodes 32 and 34;
\textcircled{2} one end of inductor 1a electrically connected to collector of transistor 31 and also to anode of diode 32, the other end to collector of transistor 33 and also to anode of diode 34, emitters of transistors 31 and 33 both connected together to the reference potential, cathodes of diodes 32 and 34 both connected together to a high potential, bases of transistors 31 and 33 respectively connected to corresponding control-and-driving signals, and the center-tap of inductor la connected to an appropriate high potential;
\textcircled{3} the push-pull inductor employing a technique of the bi-periodically time-shared driving.

14. Technique of the bi-periodically time-shared driving, cited in claim 13, whereby a pair of electrically-symmetric driving switches such as transistors depicted as 31 and 33 in FIG. 11(b) of a double-ended circuit are driven with their bases or control-in terminals both separately applied with the control-and-driving signals as those like P1 and P2 shown in FIG. 11(c), which can be described as:
a pulse-width modulation (PWM) control and driving with two periods as a cycle of a sequence as stated as follows;
switch 33 being off for the first period while switch 31 on not longer than T/2 before turning off; for the second period switch 31 being off while switch 33 on not longer than T/2 before turning off, with the end of second period as the end of a cycle of the bi-periodically time-shared driving; where T is the time of switch operating period of the circuit.

15. A two-port network component, termed unity-coupled Δ (or π) mutual capacitor or current type mutual capacitor, described in claim 1, multi-purposely used for ac circuits, is characterized as:
having its equivalent circuit configuration, the most simplified electrically, of three capacitances in Δ (or π) connections (see FIG. IV-3);
exhibiting a characteristic of pure current conversion between ports when neglecting power loss;
and, according with the unity-coupled condition that the sum of all three reciprocal values of said capacitances is zero (refer to Eq. IV-22) where the needed negative capacitances may be realized through negative impedance converters or by employing inductances operating at a constant frequency.

16. A two-port network component, termed unity-coupled T (or Y) mutual capacitor or voltage type mutual capacitor, described in claim 1, multi-purposely used for ac circuits, is characterized as:
having its equivalent circuit configuration, the most simplified electrically, of three capacitances in T (or Y) connections (see FIG. IV-4);
exhibiting a characteristic of pure voltage conversion between ports when neglecting power loss;
and, according with the unity-coupled condition that the sum of all three values of said capacitances is zero (refer to Eq. IV-24) where the needed negative capacitances may be realized through negative impedance converters or by employing inductances operating at a constant frequency.
